(19) United States
(12) Patent Application Publication
(10) Pub. No.: US 2026/0304323 A1
(43) Pub. Date: Oct. 1, 2026

(54) CODEPOINT DESIGN FOR LOW-POWER WAKE-UP SIGNALS

(71) Applicant: QUALCOMM Incorporated, San Diego, CA (US)

(72) Inventors: Nicolas CORNILLET, Lannion (FR); Huilin XU, Beijing (CN)

(21) Appl. No.: 19/570,837

(22) Filed: Mar. 18, 2026

Related U.S. Application Data
(60) Provisional application No. 63/779,525, filed on Mar. 28, 2025.

(51) Int. Cl. H04W 52/02

(52) U.S. Cl. CPC H04W 52/0235

(57) ABSTRACT

Various aspects of the present disclosure generally relate to wireless communication. In some aspects, a user equipment (UE) may monitor for, during a monitoring occasion, a low-power wake-up signal (LP-WUS) sequence including a plurality of multiplexed LP-WUS codepoints that are rate-matched according to a minimum Hamming distance that is a function of a length of the LP-WUS sequence. The UE may detect the LP-WUS sequence to obtain an LP-WUS associated with the UE, wherein each codepoint of the plurality of multiplexed LP-WUS codepoints is generated according to a set of generator matrices that are associated with the minimum Hamming distance. The UE may receive a control channel message in association with detecting the LP-WUS sequence. Numerous other aspects are described.

### CROSS-REFERENCE TO RELATED APPLICATION

This patent application claims priority to U.S. Provisional Patent Application No. 63/779,525, filed on Mar. 28, 2025, entitled “CODEPOINT DESIGN FOR LOW-POWER WAKE-UP SIGNALS,” and assigned to the assignee hereof. The disclosure of the prior application is considered part of and is incorporated by reference into this patent application.

### FIELD OF THE DISCLOSURE

Aspects of the present disclosure generally relate to wireless communication and specifically relate to techniques, apparatuses, and methods associated with codepoint design for low-power wake-up signals.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

Some wireless communication systems may implement power-saving techniques including the communication of a low-power wake-up signal (LP-WUS) that prompt a user equipment (UE) to transition from a low power state (e.g., a power-saving state) in which the UE communicates using a low complexity, low power radio receiver, to a relatively higher power state in which the UE may receive data or control messages from a network node using a main radio. In some examples, the UE may monitor for an LP-WUS including a binary sequence, known as a codepoint, which the UE may use to determine whether to transition from the low-power state, or wake up the main radio receiver, among other examples.

In some examples multiple UEs may be configured to monitor for an LP-WUS during a same monitoring occasion, thus an LP-WUS sequence may be designed such that the codepoints selectively wake up the targeted UEs (e.g., UEs with which the network node has data or control information to communicate) without triggering a false wake-up of other UEs (e.g., UEs for which the network node does not have data or control information at the time of communicating the LP-WUS).

### SUMMARY

The systems, methods, and devices of this disclosure each have several innovative aspects, no single one of which is solely responsible for the desirable attributes disclosed herein.

Some aspects described herein relate to a user equipment (UE). The UE may include a processing system. The processing system may include one or more processors and one or more code-storing memories coupled with the one or more processors. The processing system may be configured to cause the UE to monitor for, during a monitoring occasion, a low-power wake-up signal (LP-WUS) sequence including a plurality of multiplexed LP-WUS codepoints that are rate-matched according to a minimum Hamming distance that is a function of a length of the LP-WUS sequence. The processing system may be configured to cause the UE to detect the LP-WUS sequence to obtain an LP-WUS associated with the UE, wherein each codepoint of the plurality of multiplexed LP-WUS codepoints is generated according to a set of generator matrices that are associated with the minimum Hamming distance. The processing system may be configured to cause the UE to receive a control channel message in association with detecting the LP-WUS sequence.

Some aspects described herein relate to a UE. The UE may include a processing system. The processing system may include one or more processors and one or more code-storing memories coupled with the one or more processors. The processing system may be configured to cause the UE to monitor for, during a monitoring occasion, an LP-WUS sequence including a plurality of multiplexed LP-WUS codepoints that are rate-matched according to a minimum Hamming distance that is a function of a length of the LP-WUS sequence. The processing system may be configured to cause the UE to detect the LP-WUS sequence to obtain an LP-WUS associated with the UE, wherein each codepoint of the plurality of multiplexed LP-WUS codepoints is generated according to a Reed Muller encoding scheme. The processing system may be configured to cause the UE to receive a control channel message in association with detecting the LP-WUS sequence.

Some aspects described herein relate to a network node. The network node may include a processing system. The processing system may include one or more processors and one or more code-storing memories coupled with the one or more processors. The processing system may be configured to cause the network node to generate an LP-WUS sequence including a plurality of multiplexed LP-WUS codepoints that are rate-matched according to a minimum Hamming distance that is a function of a length of the LP-WUS sequence. The processing system may be configured to cause the network node to transmit, during a monitoring occasion associated with a UE, the LP-WUS sequence, wherein each codepoint of the plurality of multiplexed LP-WUS codepoints is generated according to a set of generator matrices that are associated with the minimum Hamming distance. The processing system may be configured to cause the network node to transmit a control channel message in association with transmitting the LP-WUS sequence.

Some aspects described herein relate to a network node. The network node may include a processing system. The processing system may include one or more processors and one or more code-storing memories coupled with the one or more processors. The processing system may be configured to cause the network node to generate an LP-WUS sequence including a plurality of multiplexed LP-WUS codepoints that are rate-matched according to a minimum Hamming distance that is a function of a length of the LP-WUS sequence. The processing system may be configured to cause the network node to transmit, during a monitoring occasion associated with a UE, the LP-WUS sequence, wherein each codepoint of the plurality of multiplexed LP-WUS codepoints is generated according to a Reed Muller encoding scheme. The processing system may be configured to cause the network node to transmit a control channel message in association with transmitting the LP-WUS sequence.

Some aspects described herein relate to a network node. The network node may include a processing system. The processing system may include one or more processors and one or more code-storing memories coupled with the one or more processors. The processing system may be configured to cause the network node to obtain a set of encoded information bits using a set of generator vectors. The processing system may be configured to cause the network node to apply a rate-matching pattern to the set of encoded information bits to generate an LP-WUS sequence including a plurality of multiplexed LP-WUS codepoints, wherein the rate-matching pattern is a function of a length of the LP-WUS sequence.

Some aspects described herein relate to a method of wireless communication performed by a UE. The method may include monitoring for, during a monitoring occasion, an LP-WUS sequence including a plurality of multiplexed LP-WUS codepoints that are rate-matched according to a minimum Hamming distance that is a function of a length of the LP-WUS sequence. The method may include detecting the LP-WUS sequence to obtain an LP-WUS associated with the UE, wherein each codepoint of the plurality of multiplexed LP-WUS codepoints is generated according to a set of generator matrices that are associated with the minimum Hamming distance. The method may include receiving a control channel message in association with detecting the LP-WUS sequence.

Some aspects described herein relate to a method of wireless communication performed by a UE. The method may include monitoring for, during a monitoring occasion, an LP-WUS sequence including a plurality of multiplexed LP-WUS codepoints that are rate-matched according to a minimum Hamming distance that is a function of a length of the LP-WUS sequence. The method may include detecting the LP-WUS sequence to obtain an LP-WUS associated with the UE, wherein each codepoint of the plurality of multiplexed LP-WUS codepoints is generated according to a Reed Muller encoding scheme. The method may include receiving a control channel message in association with detecting the LP-WUS sequence.

Some aspects described herein relate to a method of wireless communication performed by a network node. The method may include generating an LP-WUS sequence including a plurality of multiplexed LP-WUS codepoints that are rate-matched according to a minimum Hamming distance that is a function of a length of the LP-WUS sequence. The method may include transmitting, during a monitoring occasion associated with a UE, the LP-WUS sequence, wherein each codepoint of the plurality of multiplexed LP-WUS codepoints is generated according to a set of generator matrices that are associated with the minimum Hamming distance. The method may include transmitting a control channel message in association with transmitting the LP-WUS sequence.

Some aspects described herein relate to a method of wireless communication performed by a network node. The method may include generating an LP-WUS sequence including a plurality of multiplexed LP-WUS codepoints that are rate-matched according to a minimum Hamming distance that is a function of a length of the LP-WUS sequence. The method may include transmitting, during a monitoring occasion associated with a UE, the LP-WUS sequence, wherein each codepoint of the plurality of multiplexed LP-WUS codepoints is generated according to a Reed Muller encoding scheme. The method may include transmitting a control channel message in association with transmitting the LP-WUS sequence.

Some aspects described herein relate to a method of wireless communication. The method may include obtaining a set of encoded information bits using a set of generator vectors. The method may include applying a rate-matching pattern to the set of encoded information bits to generate an LP-WUS sequence including a plurality of multiplexed LP-WUS codepoints, wherein the rate-matching pattern is a function of a length of the LP-WUS sequence.

Some aspects described herein relate to a non-transitory computer-readable medium that stores a set of instructions for wireless communication by a UE. The set of instructions, when executed by one or more processors of the UE, may cause the UE to monitor for, during a monitoring occasion, an LP-WUS sequence including a plurality of multiplexed LP-WUS codepoints that are rate-matched according to a minimum Hamming distance that is a function of a length of the LP-WUS sequence. The set of instructions, when executed by one or more processors of the UE, may cause the UE to detect the LP-WUS sequence to obtain an LP-WUS associated with the UE, wherein each codepoint of the plurality of multiplexed LP-WUS codepoints is generated according to a set of generator matrices that are associated with the minimum Hamming distance. The set of instructions, when executed by one or more processors of the UE, may cause the UE to receive a control channel message in association with detecting the LP-WUS sequence.

Some aspects described herein relate to a non-transitory computer-readable medium that stores a set of instructions for wireless communication by a UE. The set of instructions, when executed by one or more processors of the UE, may cause the UE to monitor for, during a monitoring occasion, an LP-WUS sequence including a plurality of multiplexed LP-WUS codepoints that are rate-matched according to a minimum Hamming distance that is a function of a length of the LP-WUS sequence. The set of instructions, when executed by one or more processors of the UE, may cause the UE to detect the LP-WUS sequence to obtain an LP-WUS associated with the UE, wherein each codepoint of the plurality of multiplexed LP-WUS codepoints is generated according to a Reed Muller encoding scheme. The set of instructions, when executed by one or more processors of the UE, may cause the UE to receive a control channel message in association with detecting the LP-WUS sequence.

Some aspects described herein relate to a non-transitory computer-readable medium that stores a set of instructions for wireless communication by a network node. The set of instructions, when executed by one or more processors of the network node, may cause the network node to generate an LP-WUS sequence including a plurality of multiplexed LP-WUS codepoints that are rate-matched according to a minimum Hamming distance that is a function of a length of the LP-WUS sequence. The set of instructions, when executed by one or more processors of the network node, may cause the network node to transmit, during a monitoring occasion associated with a UE, the LP-WUS sequence, wherein each codepoint of the plurality of multiplexed LP-WUS codepoints is generated according to a set of generator matrices that are associated with the minimum Hamming distance. The set of instructions, when executed by one or more processors of the network node, may cause the network node to transmit a control channel message in association with transmitting the LP-WUS sequence.

Some aspects described herein relate to a non-transitory computer-readable medium that stores a set of instructions for wireless communication by a network node. The set of instructions, when executed by one or more processors of the network node, may cause the network node to generate an LP-WUS sequence including a plurality of multiplexed LP-WUS codepoints that are rate-matched according to a minimum Hamming distance that is a function of a length of the LP-WUS sequence. The set of instructions, when executed by one or more processors of the network node, may cause the network node to transmit, during a monitoring occasion associated with a UE, the LP-WUS sequence, wherein each codepoint of the plurality of multiplexed LP-WUS codepoints is generated according to a Reed Muller encoding scheme. The set of instructions, when executed by one or more processors of the network node, may cause the network node to transmit a control channel message in association with transmitting the LP-WUS sequence.

Some aspects described herein relate to a non-transitory computer-readable medium that stores a set of instructions for wireless communication by a network node. The set of instructions, when executed by one or more processors of the network node, may cause the network node to obtain a set of encoded information bits using a set of generator vectors. The set of instructions, when executed by one or more processors of the network node, may cause the network node to apply a rate-matching pattern to the set of encoded information bits to generate an LP-WUS sequence including a plurality of multiplexed LP-WUS codepoints, wherein the rate-matching pattern is a function of a length of the LP-WUS sequence.

Some aspects described herein relate to an apparatus for wireless communication. The apparatus may include means for monitoring for, during a monitoring occasion, an LP-WUS sequence including a plurality of multiplexed LP-WUS codepoints that are rate-matched according to a minimum Hamming distance that is a function of a length of the LP-WUS sequence. The apparatus may include means for detecting the LP-WUS sequence to obtain an LP-WUS associated with the apparatus, wherein each codepoint of the plurality of multiplexed LP-WUS codepoints is generated according to a set of generator matrices that are associated with the minimum Hamming distance. The apparatus may include means for receiving a control channel message in association with detecting the LP-WUS sequence.

Some aspects described herein relate to an apparatus for wireless communication. The apparatus may include means for monitoring for, during a monitoring occasion, an LP-WUS sequence including a plurality of multiplexed LP-WUS codepoints that are rate-matched according to a minimum Hamming distance that is a function of a length of the LP-WUS sequence. The apparatus may include means for detecting the LP-WUS sequence to obtain an LP-WUS associated with the apparatus, wherein each codepoint of the plurality of multiplexed LP-WUS codepoints is generated according to a Reed Muller encoding scheme. The apparatus may include means for receiving a control channel message in association with detecting the LP-WUS sequence.

Some aspects described herein relate to an apparatus for wireless communication. The apparatus may include means for generating an LP-WUS sequence including a plurality of multiplexed LP-WUS codepoints that are rate-matched according to a minimum Hamming distance that is a function of a length of the LP-WUS sequence. The apparatus may include means for transmitting, during a monitoring occasion associated with a UE, the LP-WUS sequence, wherein each codepoint of the plurality of multiplexed LP-WUS codepoints is generated according to a set of generator matrices that are associated with the minimum Hamming distance. The apparatus may include means for transmitting a control channel message in association with transmitting the LP-WUS sequence.

Some aspects described herein relate to an apparatus for wireless communication. The apparatus may include means for generating an LP-WUS sequence including a plurality of multiplexed LP-WUS codepoints that are rate-matched according to a minimum Hamming distance that is a function of a length of the LP-WUS sequence. The apparatus may include means for transmitting, during a monitoring occasion associated with a UE, the LP-WUS sequence, wherein each codepoint of the plurality of multiplexed LP-WUS codepoints is generated according to a Reed Muller encoding scheme. The apparatus may include means for transmitting a control channel message in association with transmitting the LP-WUS sequence.

Some aspects described herein relate to an apparatus for wireless communication. The apparatus may include means for obtaining a set of encoded information bits using a set of generator vectors. The apparatus may include means for applying a rate-matching pattern to the set of encoded information bits to generate an LP-WUS sequence including a plurality of multiplexed LP-WUS codepoints, wherein the rate-matching pattern is a function of a length of the LP-WUS sequence.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example of a low-power wakeup radio (LP-WUR) and a low-power wakeup signal (LP-WUS).

FIGS. 3A and 3B are diagrams illustrating examples of maximum likelihood detection architectures.

FIG. 4 is a diagram of an example associated with codepoint design for LP-WUSs.

FIG. 5 is a diagram of an example associated with codepoint design for low-power wake-up signals.

FIG. 6 is a diagram illustrating an example process performed, for example, at a user equipment (UE) or an apparatus of a UE.

FIG. 7 is a diagram illustrating an example process performed, for example, at a UE or an apparatus of a UE.

FIG. 8 is a diagram illustrating an example process performed, for example, at a network node or an apparatus of a network node.

FIG. 9 is a diagram illustrating an example process performed, for example, at a network node or an apparatus of a network node.

FIG. 10 is a diagram illustrating an example process performed, for example, at a network node or an apparatus of a network node.

FIG. 11 is a diagram of an example apparatus for wireless communication.

FIG. 12 is a diagram of an example apparatus for wireless communication.

### DETAILED DESCRIPTION

In some wireless communication systems, a user equipment (UE) may be capable of implementing one or more low power operations to conserve battery life, particularly in scenarios involving machine-type communications where devices may need to operate for extended periods without human intervention. For example, a UE may be configured with multiple operational modes including a sleep mode (e.g., a low power mode) during which a main radio of the UE can be powered down or put into an idle mode and activated upon receiving a specific wake-up signal. In some examples, the UE may transition out of a sleep mode in response to receiving a low power wake-up signal (LP-WUS) that is detected by a low power radio of the UE, which operates using less power than the main radio of the UE.

An LP-WUS may include one or more codepoints to prompt a set of one or more UEs to transition out of the sleep mode. In some examples, one or more UEs may be configured to monitor for an LP-WUS during multiplexed resources of a same monitoring occasion and thus, codepoints may be designed such that the intended UEs are woken up without causing other UEs (e.g., sharing the same monitoring occasion) to unintentionally wake up. Such codepoints may be designed for UEs implementing correlation-based detectors when a smallest quantity of bit positions in which any two distinct codepoints in the LP-WUS sequence differ includes at least half the length of the codepoints. For example, it may be possible to design such sets of codepoints for correlation-based detectors as long as the minimum Hamming distance of the set is at least half the length of the codepoints. Otherwise, UE detectors may use maximum likelihood detection, which may include a fairly more complex method of detection and may be a more resource intensive procedure than correlation-based detection.

Various aspects relate generally to the design and transmission of one or more LP-WUSs to prioritize designs that are more easily detected using less-resource intensive detection methods and to decrease reliance on resource intensive detection techniques in wireless communication systems. Some aspects more specifically relate to a UE monitoring for an LP-WUS sequence during a monitoring occasion, where the LP-WUS sequence includes a plurality of multiplexed LP-WUS codepoints that are rate-matched according to a minimum Hamming distance as a function of a length of the LP-WUS sequence. In some aspects, the UE may detect an LP-WUS sequence to obtain an LP-WUS associated with the UE, wherein each codepoint is generated according to a set of generator matrices associated with the minimum Hamming distance. In some aspects, the UE may receive a control channel message in association with detecting the LP-WUS sequence.

In some aspects, the UE may rate-dematch the LP-WUS sequence and may apply a fast Hadamard transform to the rate-dematched LP-WUS sequence to obtain the LP-WUS associated with the UE. The multiplexed LP-WUS codepoints may be encoded to wake up a subset of UEs, and each codepoint may be generated by multiplying each of a set of binary vectors of a length, k, by a generator matrix from a set of generator matrices. In some aspects, each of the generator matrices may include a plurality of non-zero binary vectors according to the selected length of the LP-WUS sequence.

In some aspects, the generator matrices may be constructed by omitting at least one all-zero row from each matrix. In some aspects, the set of generator matrices may include a quantity of matrices, with the option to swap rows to satisfy the minimum Hamming distance for various sequence lengths.

Particular aspects of the subject matter described in this disclosure can be implemented to realize one or more of the following potential technical benefits. By generating LP-WUS codepoints using generator matrices that maintain a minimum Hamming distance, the UE can detect wake-up signals with lower complexity detection methods such as correlation-based detection rather than more computationally intensive maximum likelihood detection methodologies. This approach may conserve processing resources and energy consumption, which may be particularly beneficial for UEs implementing low power operations. The adaptability of the methods to various sequence lengths ensures efficient utilization of network resources and enhances the reliability of the wireless communication system. Furthermore, the precision in waking up the intended UEs may maintain the integrity of network communication protocols and may conserve battery life for UEs. As a result, the examples of codepoint design for LP-WUS described herein may conserve processing resources, memory resources, network resources, or the like.

As used herein, the term “codepoint” refers to a binary sequence that is transmitted as part of a LP-WUS and is monitored for by a UE. Each codepoint is associated with a specific UE or set of UEs, and detection of the codepoint by the UE triggers a transition from a low power state to a higher power state for communication with a network node. Codepoints are designed so that only the intended UEs wake up in response to their assigned codepoint, thereby minimizing false wake-ups among other UEs sharing the same monitoring occasion. Codepoints may be generated according to the encoding schemes and generator matrices described herein, and may be multiplexed in LP-WUS sequences to enable selective wake-up signaling.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mm Wave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

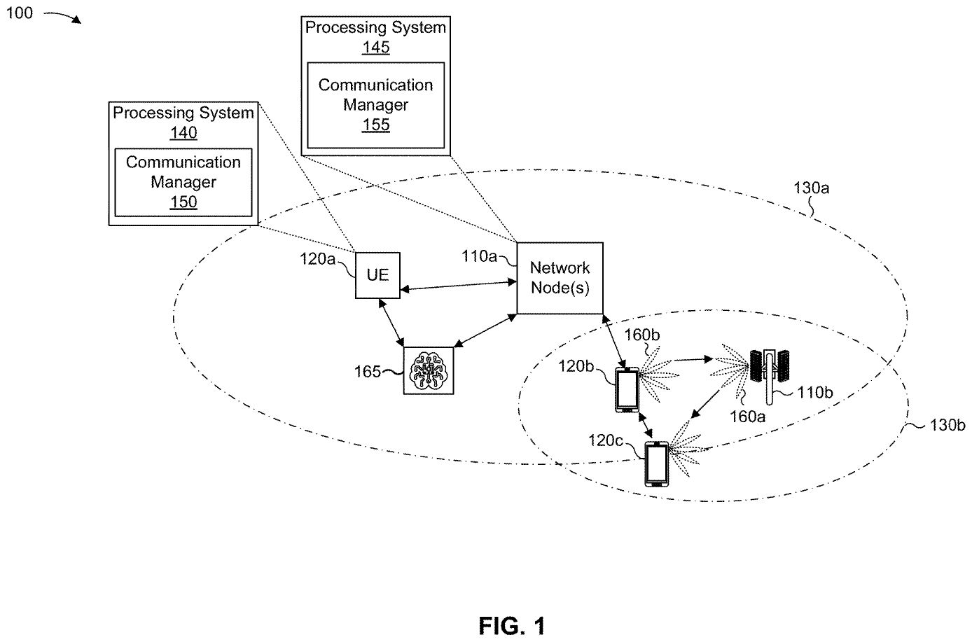

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHZ), FR2 (24.25 GHz through 52.6 GHz), FR3 (7.125 GHz through 24.25 GHZ), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHZ, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IOT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may monitor for, during a monitoring occasion, an LP-WUS sequence including a plurality of multiplexed LP-WUS codepoints that are rate-matched according to a minimum Hamming distance that is a function of a length of the LP-WUS sequence; detect the LP-WUS sequence to obtain an LP-WUS associated with the UE, wherein each codepoint of the plurality of multiplexed LP-WUS codepoints is generated according to a set of generator matrices that are associated with the minimum Hamming distance; and receive a control channel message in association with detecting the LP-WUS sequence. Additionally, or alternatively, the communication manager 150 may perform one or more other operations described herein.

In some aspects, the UE 120 may include a communication manager 150. As described in more detail elsewhere herein, the communication manager 150 may monitor for, during a monitoring occasion, an LP-WUS sequence including a plurality of multiplexed LP-WUS codepoints that are rate-matched according to a minimum Hamming distance that is a function of a length of the LP-WUS sequence; detect the LP-WUS sequence to obtain an LP-WUS associated with the UE 120, wherein each codepoint of the plurality of multiplexed LP-WUS codepoints is generated according to a Reed Muller encoding scheme; and receive a control channel message in association with detecting the LP-WUS sequence. Additionally, or alternatively, the communication manager 150 may perform one or more other operations described herein.

In some aspects, the network node 110 may include a communication manager 155. As described in more detail elsewhere herein, the communication manager 155 may generate an LP-WUS sequence including a plurality of multiplexed LP-WUS codepoints that are rate-matched according to a minimum Hamming distance that is a function of a length of the LP-WUS sequence; transmit, during a monitoring occasion associated with a UE 120, the LP-WUS sequence, wherein each codepoint of the plurality of multiplexed LP-WUS codepoints is generated according to a set of generator matrices that are associated with the minimum Hamming distance; and transmit a control channel message in association with transmitting the LP-WUS sequence. Additionally, or alternatively, the communication manager 155 may perform one or more other operations described herein.

In some aspects, the network node 110 may include a communication manager 155. As described in more detail elsewhere herein, the communication manager 155 may generate an LP-WUS sequence including a plurality of multiplexed LP-WUS codepoints that are rate-matched according to a minimum Hamming distance that is a function of a length of the LP-WUS sequence; transmit, during a monitoring occasion associated with a UE 120, the LP-WUS sequence, wherein each codepoint of the plurality of multiplexed LP-WUS codepoints is generated according to a Reed Muller encoding scheme; and transmit a control channel message in association with transmitting the LP-WUS sequence. Additionally, or alternatively, the communication manager 155 may perform one or more other operations described herein.

In some aspects, the network node 110 may include a communication manager 155. As described in more detail elsewhere herein, the communication manager 155 may obtain a set of encoded information bits using a set of generator vectors; and apply a rate-matching pattern to the set of encoded information bits to generate an LP-WUS sequence including a plurality of multiplexed LP-WUS codepoints, wherein the rate-matching pattern is a function of a length of the LP-WUS sequence. Additionally, or alternatively, the communication manager 155 may perform one or more other operations described herein.

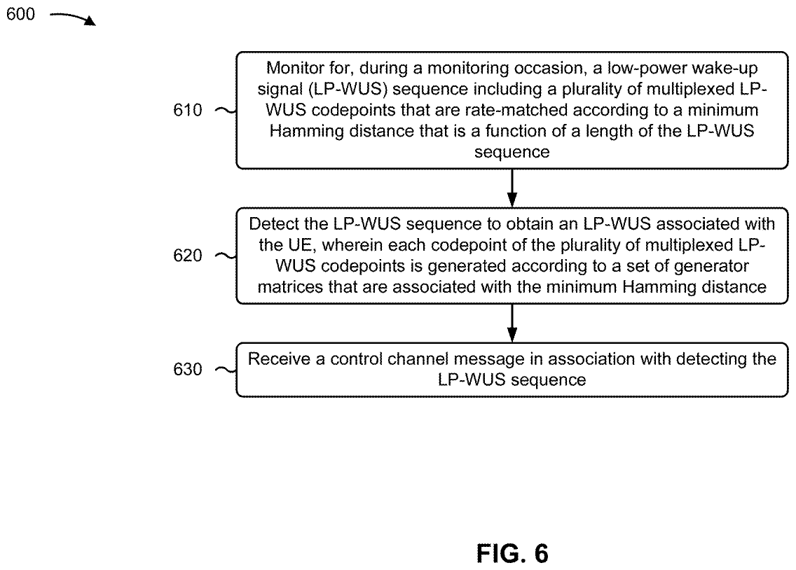

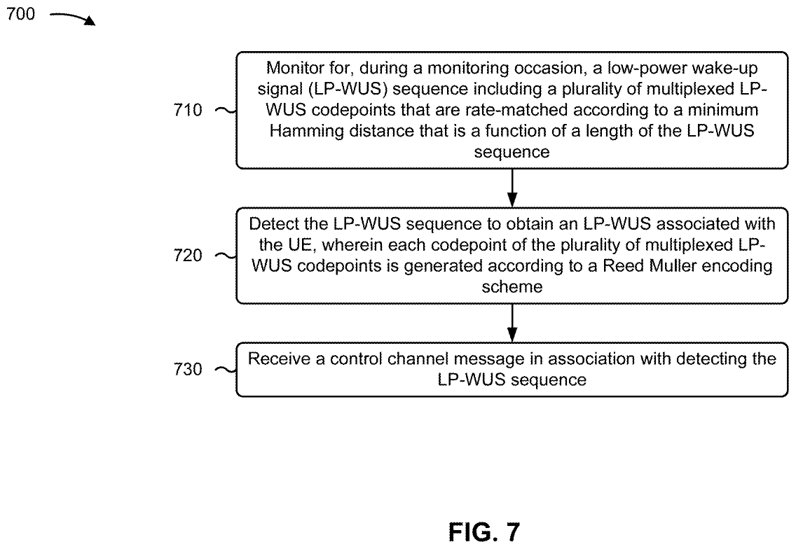

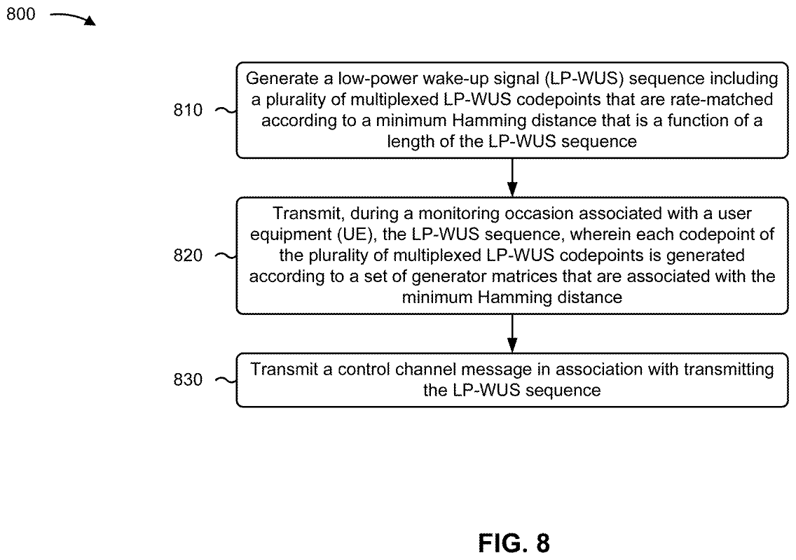

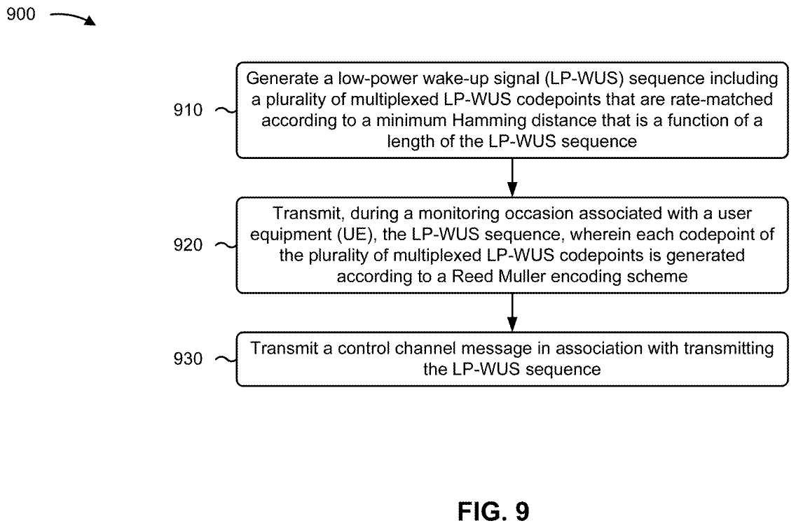

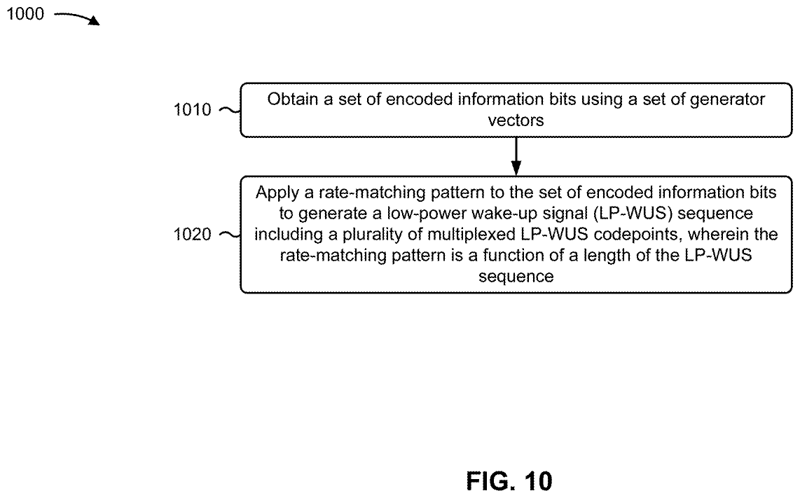

The network node 110, the processing system 145 of the network node 110, the UE 120, the processing system 140 of the UE 120, or any other component(s) of FIG. 1 may implement one or more techniques or perform one or more operations associated with codepoint design for LP-WUS, as described in more detail elsewhere herein. For example, the processing system 145 of the network node 110, or the processing system 140 of the UE 120 may perform or direct operations of, for example, process 600 of FIG. 6, process 700 of FIG. 7, process 800 of FIG. 8, process 900 of FIG. 9, process 1000 of FIG. 10, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 600 of FIG. 6, process 700 of FIG. 7, process 800 of FIG. 8, process 900 of FIG. 9, process 1000 of FIG. 10, or other processes as described herein. In some examples, executing instructions may include running the instructions, converting the instructions, compiling the instructions, or interpreting the instructions, among other examples.

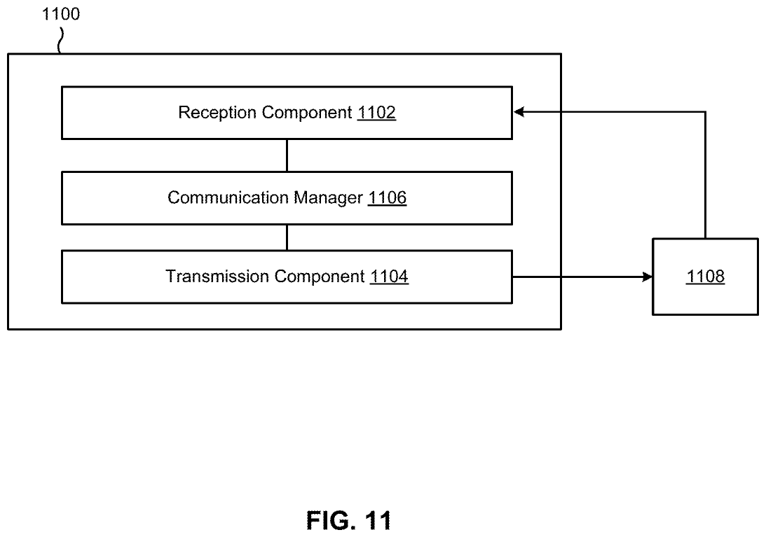

In some aspects, the UE 120 includes means for monitoring for, during a monitoring occasion, an LP-WUS sequence including a plurality of multiplexed LP-WUS codepoints that are rate-matched according to a minimum Hamming distance that is a function of a length of the LP-WUS sequence; means for detecting the LP-WUS sequence to obtain an LP-WUS associated with the UE 120, wherein each codepoint of the plurality of multiplexed LP-WUS codepoints is generated according to a set of generator matrices that are associated with the minimum Hamming distance; or means for receiving a control channel message in association with detecting the LP-WUS sequence. The means for the UE 120 to perform operations described herein may include, for example, one or more of communication manager 150, processing system 140, a radio, one or more RF chains, one or more transceivers, one or more antennas, one or more modems, a reception component (for example, reception component 1102 depicted and described in connection with FIG. 11), or a transmission component (for example, transmission component 1104 depicted and described in connection with FIG. 11), among other examples.

In some aspects, the UE includes means for monitoring for, during a monitoring occasion, an LP-WUS sequence including a plurality of multiplexed LP-WUS codepoints that are rate-matched according to a minimum Hamming distance that is a function of a length of the LP-WUS sequence; means for detecting the LP-WUS sequence to obtain an LP-WUS associated with the UE 120, wherein each codepoint of the plurality of multiplexed LP-WUS codepoints is generated according to a Reed Muller encoding scheme; or means for receiving a control channel message in association with detecting the LP-WUS sequence. The means for the UE 120 to perform operations described herein may include, for example, one or more of communication manager 150, processing system 140, a radio, one or more RF chains, one or more transceivers, one or more antennas, one or more modems, a reception component (for example, reception component 1102 depicted and described in connection with FIG. 11), or a transmission component (for example, transmission component 1104 depicted and described in connection with FIG. 11), among other examples.

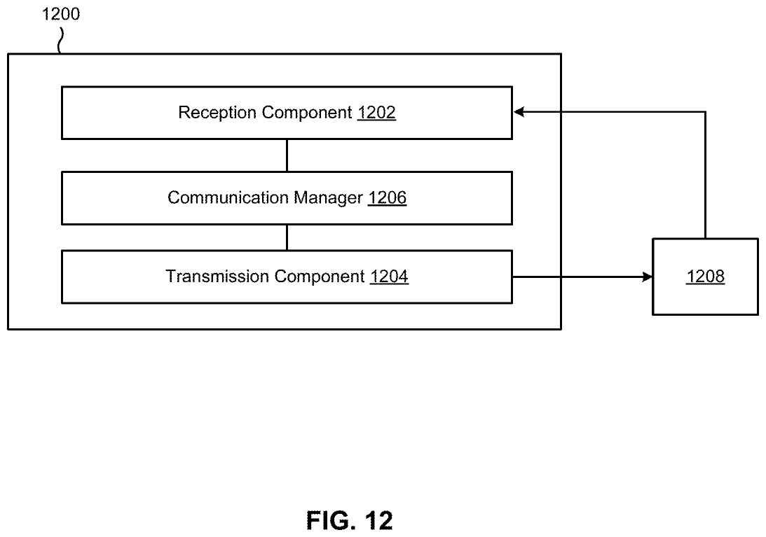

In some aspects, the network node 110 includes means for generating an LP-WUS sequence including a plurality of multiplexed LP-WUS codepoints that are rate-matched according to a minimum Hamming distance that is a function of a length of the LP-WUS sequence; means for transmitting, during a monitoring occasion associated with a UE, the LP-WUS sequence, wherein each codepoint of the plurality of multiplexed LP-WUS codepoints is generated according to a set of generator matrices that are associated with the minimum Hamming distance; or means for transmitting a control channel message in association with transmitting the LP-WUS sequence. The means for the network node 110 to perform operations described herein may include, for example, one or more of communication manager 155, processing system 145, a radio, one or more RF chains, one or more transceivers, one or more antennas, one or more modems, a reception component (for example, reception component 1202 depicted and described in connection with FIG. 12), or a transmission component (for example, transmission component 1204 depicted and described in connection with FIG. 12), among other examples.

In some aspects, the network node 110 includes means for generating an LP-WUS sequence including a plurality of multiplexed LP-WUS codepoints that are rate-matched according to a minimum Hamming distance that is a function of a length of the LP-WUS sequence; means for transmitting, during a monitoring occasion associated with a UE 120, the LP-WUS sequence, wherein each codepoint of the plurality of multiplexed LP-WUS codepoints is generated according to a Reed Muller encoding scheme; or means for transmitting a control channel message in association with transmitting the LP-WUS sequence. The means for the network node 110 to perform operations described herein may include, for example, one or more of communication manager 155, processing system 145, a radio, one or more RF chains, one or more transceivers, one or more antennas, one or more modems, a reception component (for example, reception component 1202 depicted and described in connection with FIG. 12), or a transmission component (for example, transmission component 1204 depicted and described in connection with FIG. 12), among other examples.

In some aspects, the network node 110 includes means for obtaining a set of encoded information bits using a set of generator vectors; or means for applying a rate-matching pattern to the set of encoded information bits to generate an LP-WUS sequence including a plurality of multiplexed LP-WUS codepoints, wherein the rate-matching pattern is a function of a length of the LP-WUS sequence. The means for the network node 110 to perform operations described herein may include, for example, one or more of communication manager 155, processing system 145, a radio, one or more RF chains, one or more transceivers, one or more antennas, one or more modems, a reception component (for example, reception component 1202 depicted and described in connection with FIG. 12), or a transmission component (for example, transmission component 1204 depicted and described in connection with FIG. 12), among other examples.

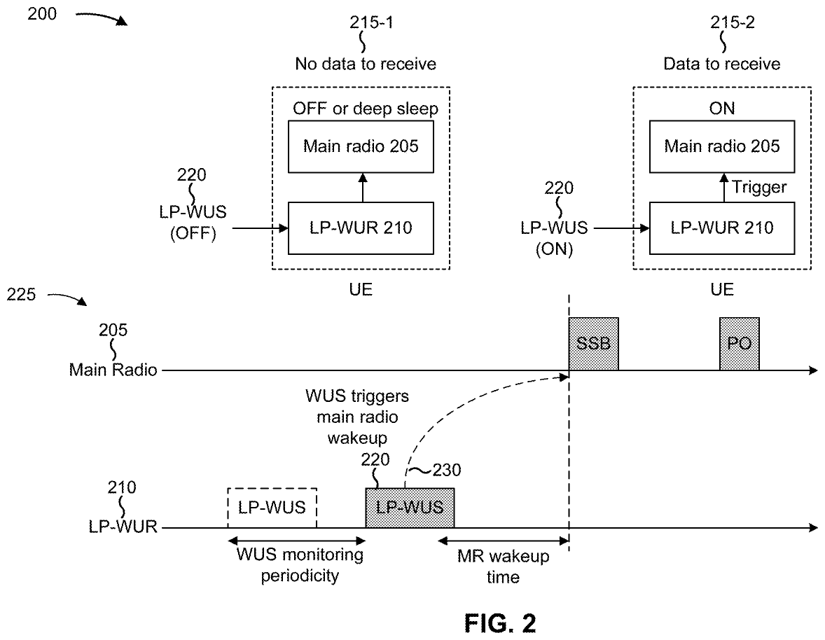

FIG. 2 is a diagram illustrating an example 200 of a low-power wakeup radio (LP-WUR) and an LP-WUS. As shown in FIG. 2, a UE (such as UE 120) may be equipped with a communication system that includes a main radio (illustrated as “MR”) 205 and an LP-WUR 210 to reduce power consumption and enable low latency. For example, power saving and low latency are often conflicting goals because placing one or more components into a sleep state more often to reduce power consumption also increases latency (e.g., because data cannot be transmitted or received while the one or more components are in the sleep state), and because reducing the time that one or more components spend in a sleep state to reduce latency can lead to increased power consumption. Accordingly, as shown in FIG. 2, the UE may be equipped with the LP-WUR 210, which may be considered a companion receiver that can be used with a main radio 205 to reduce power consumption and latency.

For example, in some aspects, the UE may generally use the main radio 205 to transmit or receive user data, and the main radio 205 may be turned off or operated in a deep sleep state unless there is user data to transmit or receive. Furthermore, the LP-WUR 210 may serve as a simple wakeup receiver for the main radio 205, and the LP-WUR 210 may be active and monitoring for an LP-WUS while the main radio 205 is off or in the deep sleep state. For example, reference number 215-1 depicts a first state associated with the main radio 205 and the LP-WUR 210 where there is no user data to be provided to the main radio 205. In such cases, the main radio 205 may be off or operated in the deep sleep state unless there is user data to transmit, and the LP-WUR 210 may monitor for an LP-WUS (for example, continuously, or periodically in monitoring occasions that are separated in time). Furthermore, reference number 215-2 depicts a second state associated with the main radio 205 and the LP-WUR 210 where there is user data for the main radio 205. In such cases, the LP-WUR 210 may receive an LP-WUS 220 (such as from a network node 110) and may provide a trigger to wake or otherwise activate the main radio 205 based on detecting the LP-WUS 220. Accordingly, the main radio 205 may then transmit or receive user data.

In general, the LP-WUR 210 may consume very little power (for example a target power consumption less than 100 microwatts (μW) in the active state), which may be achieved using simple modulation schemes (for example, on-off keying (OOK)), a narrow bandwidth (for example, less than 5 MHz), or other suitable techniques. In this way, the LP-WUR 210 can be used to reduce the time that the main radio 205 spends in an on state or may avoid unnecessarily waking the main radio 205 from the off or deep sleep state when there is no user data to transmit or receive, which tends to be costly from a power consumption perspective. Furthermore, because the LP-WUR 210 has a very low power consumption, the LP-WUR 210 can be used to frequently or continuously perform LP-WUS monitoring, which may improve latency because the main radio 205 can be woken up when there is user data that the main radio 205 needs to receive. For example, the LP-WUR 210 may not suffer from the latency versus power efficiency tradeoff associated with duty cycling schemes, such as discontinuous reception (DRX). Furthermore, in addition to performing LP-WUS monitoring, which may be used for paging reception, the LP-WUR 210 may monitor a low power synchronization signal (LP-SS) for time and frequency tracking and radio resource management (RRM) measurement. In this way, by monitoring the LP-SS, serving cell or neighbor cell monitoring can be offloaded from the main radio 205 to the LP-WUR 210 to reduce how often the main radio 205 is woken up, which can further reduce power consumption.

In some aspects, the LP-WUR 210 may include an OOK WUR (also referred to as an envelope detector (ED) WUR). An OOK WUR may only detect the amplitude (such as the magnitude) of a received signal. A UE that uses an OOK WUR may detect the phase of a received signal by activating the main radio 205.

In some aspects, the LP-WUR 210 may include an OFDM WUR (which may be referred to as an in-phase and quadrature (IQ) WUR). An OFDM WUR can detect both the amplitude and phase of a received signal. For example, an OFDM WUR can obtain first information that is modulated onto a signal using OOK modulation, and second information that is modulated onto the signal using phase modulation.

In some aspects, as shown by reference number 225, one application of the LP-WUR 210 is to monitor the LP-WUS 220 for paging monitoring, which can be used to reduce unnecessary paging reception performed by the main radio 205. For example, as shown in FIG. 2, the LP-WUR 210 may be configured to monitor for an LP-WUS 220 (while the main radio 205 is off or in a deep sleep state) according to a wake-up signal (WUS) monitoring periodicity. For example, the LP-WUR 210 may monitor for the LP-WUS 220 in periodic LP-WUS monitoring occasions that are spaced in time according to the WUS monitoring periodicity. Alternatively, although not explicitly shown in FIG. 2, the LP-WUR 210 may be configured to continuously monitor for the LP-WUS 220. In general, a network node may transmit an LP-WUS 220 to a UE only in cases where there is a paging message that needs to be sent to the UE while the UE is in an idle or inactive state (such as an RRC idle or RRC inactive state). In such cases, as shown by reference number 230, the LP-WUR 210 may receive and detect the LP-WUS 220, which may trigger the LP-WUR 210 to wake up the main radio 205. In some aspects, the LP-WUS 220 may be a sequence-based WUS, which may include a predefined set of sequences (implemented, for example, using OOK modulation or phase modulation). As shown, the main radio 205 may wake up after a main radio wakeup time, and may then start to monitor one or more synchronization signal block (SSB) transmissions to obtain synchronization with the network node before monitoring and receiving the paging message in a subsequent PO. Otherwise, in cases where the LP-WUR 210 does not detect the LP-WUS 220, the main radio 205 may remain in the deep sleep state to save power.

A network node may encode an LP-WUS sequence using various encoding techniques. One encoding technique includes the use of Reed Muller codes. A Reed Muller code is a class of linear block codes that is used in various wireless networks. A Reed Muller code may be defined by an order r and a dimension m, where 0≤r≤m. For a Reed Muller code with an order r and a dimension m, a block length may be defined as N=2^{m}, and the maximum payload size of the Reed Muller code (e.g., the quantity of information bits that the Reed Muller code is capable of carrying) is given by

$$K = {\sum }_{j = 0}^{r} ( \begin{matrix}m \\ j\end{matrix} )$$

To encode an information bit vector using a Reed Muller code, a transmitter may generate a Reed Muller generating matrix and may right-multiply the information bit vector with the Reed Muller generating matrix, where the multiplication is in the binary field. The information bit vector may include a row vector, in which case a 2\hat{ }m by K matrix may be right-multiplied with the 1 by K column vector to generate a codeword the of size 1 by 2\hat{ }m. The transmitter may generate the Reed Muller generating matrix by generating a tensor product of a binary Hadamard matrix (e.g., a 2×2 binary Hadamard matrix). The resulting matrix may be a 2³×2³ binary matrix. To obtain the Reed Muller generating matrix from the tensor product of the binary Hadamard matrix, the transmitter may identify a particular quantity of row vectors having the greatest Hamming weight (e.g., having the greatest quantity of 1-value bits).

In some examples, the LP-WUS sequence bits (e.g., including the encoded source bits that are transmitted to the receiver over a wireless channel) may be demodulated using maximum likelihood detection, such that detected bits that are decoded or otherwise determined UE approximately reconstruct the source bits. In some examples, an LP-WUS may include one or more codepoints to prompt a set of one or more UEs to transition out of the sleep mode. In some examples, one or more UEs may be configured to monitor for an LP-WUS during multiplexed resources of a same monitoring occasions and thus, codepoints may be designed such that the intended UEs are woken up without, without causing other UEs (e.g., sharing the same monitoring occasion) to unintentionally wake-up. Such codepoints may be designed for UEs implementing correlation-based detectors when a smallest quantity of bit positions in which any two distinct codepoints in the LP-WUS sequence differ includes at least half the length of the codepoints. For example, it may be possible to design such sets of codepoints for correlation-based detectors as long as the minimum Hamming distance of the set is at least half the length of the codepoints. Otherwise, UE detectors may more frequently use maximum likelihood detection for some lengths of sequences when the minimum hamming distance is less than half the sequence length, which may include a fairly more complex method of detection and may be a more resource intensive procedure than correlation-based detection.

As indicated above, FIG. 2 is provided as an example. Other examples may differ from what is described with respect to FIG. 2.

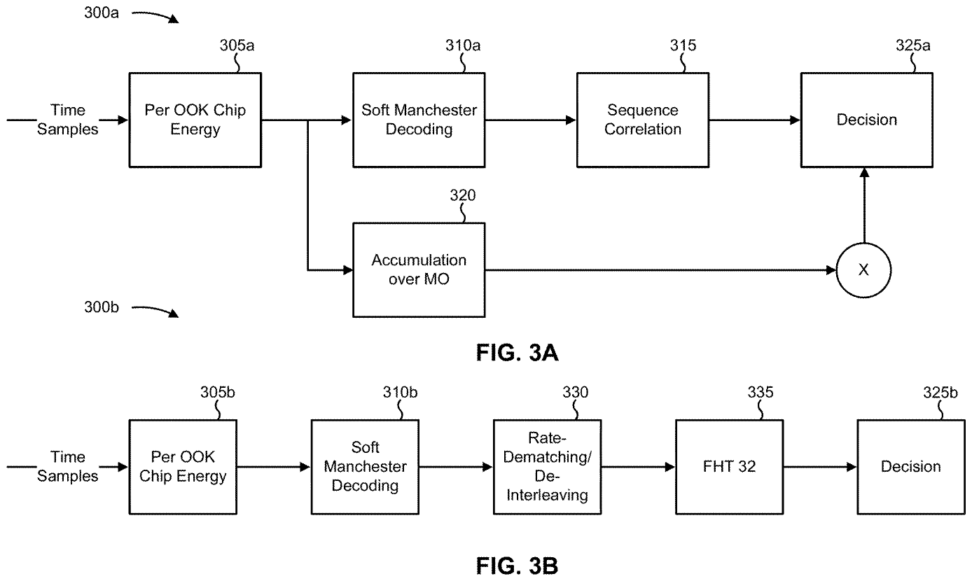

FIGS. 3A and 3B are diagrams illustrating example 300a and 300b of maximum likelihood detection architectures.

The example 300a illustrates correlation-based maximum likelihood detection. Correlation-based maximum likelihood detection is employed in wireless communication systems to efficiently identify LP-WUS sequences. In this approach, a receiver computes the correlation between the received sequence and each candidate codepoint from a predefined set. The codepoint yielding the highest correlation value is selected as the most likely transmitted sequence, thereby facilitating robust detection with minimal computational complexity.

The effectiveness of correlation-based detection depends on the codepoint design, specifically the minimum Hamming distance between codepoints. When the minimum Hamming distance is at least half the codepoint length, the receiver can reliably distinguish between codepoints using correlation-based detection. This minimizes the probability of false wake-ups and ensures that only the intended UE responds to the LP-WUS sequence during a monitoring occasion.

Correlation-based maximum likelihood detection is particularly advantageous for low-power devices, such as LP-WURs, where energy efficiency is critical. By leveraging codepoints with sufficient Hamming distance and maximizing correlation, the detection process avoids the need for more resource-intensive maximum likelihood algorithms. This enables efficient and accurate wake-up signaling in wireless communication networks, supporting power-saving operations without compromising reliability.

As shown by reference number 305a, during correlation-based maximum likelihood detection, a wireless communications device processes the received signal by evaluating the per OOK chip energy of one or more time samples. For each OOK chip, the device measures the energy present in the corresponding time interval, typically by integrating or summing the squared amplitude of the received signal samples. These energy values are then compared against the expected OOK chip pattern for each candidate codepoint. The device calculates the correlation between the measured per-chip energies and the reference codepoints, identifying the codepoint with the highest correlation as the most likely transmitted sequence. This approach enables the device to efficiently and accurately detect LP-WUS sequences, leveraging the energy characteristics of OOK modulation while maintaining low computational complexity and power consumption.

As shown by reference number 310a, as part of correlation-based maximum likelihood detection, a wireless communications device performs soft Manchester decoding by processing the received signal to extract symbol-level information from the Manchester-encoded LP-WUS sequence. For each Manchester symbol, the device analyzes the amplitude and phase characteristics of the corresponding time samples, generating soft metrics that reflect the likelihood of each symbol representing a logical “0” or “1”. These soft metrics are then used to compute the correlation between the received sequence and each candidate codepoint, rather than relying solely on hard binary decisions. By leveraging soft decoding, the device improves detection sensitivity and robustness in the presence of noise or signal distortion, ultimately identifying the codepoint with the highest correlation as the most likely transmitted sequence. This method enhances the accuracy of LP-WUS detection while maintaining efficient processing suitable for low-power operation.

As shown by reference number 315, as part of correlation-based maximum likelihood detection, a wireless communications device performs sequence correlation by comparing the received signal sequence to each candidate codepoint in the LP-WUS codebook. The device processes the received sequence, typically by accumulating the product of each received symbol and the corresponding reference symbol for every codepoint under consideration. This correlation calculation yields a metric for each candidate codepoint, indicating the degree of similarity between the received sequence and the reference codepoint. The device then selects the codepoint with the highest correlation metric as the most likely transmitted sequence. By performing sequence correlation in this manner, the device efficiently identifies the intended LP-WUS codepoint, enabling reliable wake-up signaling while minimizing computational complexity and power consumption.

As shown by reference number 320, as part of correlation-based maximum likelihood detection, a wireless communications device performs accumulation over the monitoring occasion (MO) by aggregating correlation metrics across multiple time intervals in which LP-WUS sequences may be transmitted. During each MO, the device processes the received signal samples corresponding to the candidate codepoints, calculating correlation values for each interval. These correlation values are then accumulated (typically by summing or averaging) over the entire MO to enhance detection reliability and mitigate the effects of noise or transient signal fluctuations. By performing accumulation over the MO, the device increases the statistical confidence in identifying the correct LP-WUS codepoint, ensuring robust wake-up signaling for the intended UE while maintaining low power consumption and computational efficiency.

As shown by reference number 325a, as part of correlation-based maximum likelihood detection, a wireless communications device performs decision-making by evaluating the accumulated correlation metrics for each candidate codepoint after processing the received LP-WUS sequence. Once the correlation values have been calculated and, if applicable, accumulated over the monitoring occasion, the device compares these metrics to determine which codepoint exhibits the highest correlation with the received signal. The codepoint with the maximum correlation is selected as the most likely transmitted sequence, and the device initiates the appropriate wake-up response if the selected codepoint matches its assigned identifier. This decision-making process ensures that the device reliably distinguishes intended wake-up signals from background noise or unintended transmissions, enabling efficient and accurate wake-up signaling in low-power wireless communication environments.

The example 300b illustrates fast Hadamard transform (FHT)-based maximum likelihood detection. FHT maximum likelihood detection is an efficient signal processing technique utilized in wireless communication systems for identifying LP-WUS sequences. In this approach, a wireless communications device applies the FHT to the received sequence, transforming the time-domain signal into the Hadamard domain. The FHT efficiently computes the inner products between the received sequence and all possible codepoints, leveraging the orthogonality properties of Hadamard matrices to accelerate the correlation calculations.

By operating in the Hadamard domain, the device can rapidly evaluate the likelihood of each candidate codepoint, identifying the codepoint with the highest transform coefficient as the most probable transmitted sequence. This method significantly reduces computational complexity compared to conventional correlation-based detection, especially for sequences with lengths that are powers of two. The FHT enables real-time processing and low-latency detection, making it particularly suitable for LP-WUR applications where energy efficiency and prompt wake-up responses are critical.

FHT maximum likelihood detection also enhances robustness in noisy environments, as the transform inherently separates signal components and suppresses interference. The device can further combine FHT metrics with soft decoding or accumulation over MO to improve detection accuracy. Overall, FHT maximum likelihood detection provides a scalable and power-efficient solution for reliable LP-WUS identification, supporting advanced wake-up signaling in modern wireless communication networks.

As shown by reference number 305b, as part of FHT-based maximum likelihood detection, a wireless communications device evaluates the per OOK chip energy of one or more time samples by measuring the energy present in each chip interval of the received signal. For each OOK chip, the device integrates or sums the squared amplitudes of the relevant time samples to obtain a set of energy values representing the chip sequence. These energy values are then assembled into a vector, which serves as the input for the FHT. The device applies the FHT to this energy vector, efficiently computing transform coefficients corresponding to all possible codepoints. The codepoint associated with the maximum coefficient is selected as the most likely transmitted sequence. This process enables the device to leverage both the energy characteristics of OOK modulation and the computational advantages of the FHT, achieving accurate and low-power LP-WUS detection.

As shown by reference number 310b, as part of FHT-based maximum likelihood detection, a wireless communications device performs soft Manchester decoding by analyzing the received signal to extract probabilistic metrics for each Manchester-encoded symbol. For each symbol interval, the device processes the amplitude and phase information of the time samples, generating soft values that indicate the likelihood of the symbol representing a logical “0” or “1.” These soft metrics are compiled into a vector, which is then input to the FHT algorithm. The device applies the FHT to the soft metric vector, rapidly computing transform coefficients for all candidate codepoints. By identifying the codepoint with the highest coefficient, the device determines the most probable transmitted sequence. This approach combines the sensitivity of soft Manchester decoding with the computational efficiency of the FHT, enabling robust and power-efficient LP-WUS detection even in challenging signal environments.

As shown by reference number 330, as part of FHT-based maximum likelihood detection, a wireless communications device performs rate-dematching or de-interleaving to reconstruct the original sequence structure from the received LP-WUS signal. The device first processes the incoming signal to reverse any rate-matching or interleaving operations applied during transmission, mapping the received symbols or energy values back to their intended positions in the codepoint sequence. This ensures that the sequence input to the FHT accurately reflects the original codepoint arrangement, preserving the orthogonality and correlation properties necessary for reliable detection. Once rate-dematching or de-interleaving is complete, the device assembles the resulting sequence into a vector and applies the FHT, efficiently calculating transform coefficients for all candidate codepoints. By restoring the proper sequence order prior to FHT processing, the device maximizes detection accuracy and enables robust identification of LP-WUS codepoints in low-power wireless communication scenarios.

As shown by reference number 335, as part of FHT-based maximum likelihood detection, a wireless communications device performs FHT-32 by applying a 32-point FHT to the received sequence or metric vector. After any necessary preprocessing steps such as rate-dematching, de-interleaving, or soft decoding, the device organizes the relevant 32-symbol sequence into a vector. The FHT-32 algorithm is then executed, efficiently computing all transform coefficients corresponding to the possible codepoints of length 32. Each coefficient represents the correlation between the received sequence and a specific codepoint in the Hadamard domain. The device identifies the codepoint associated with the maximum coefficient as the most likely transmitted LP-WUS sequence. By leveraging FHT-32, the device achieves rapid and computationally efficient detection, supporting real-time wake-up signaling and low-power operation in wireless communication environments.

As shown by reference number 325b, as part of FHT-based maximum likelihood detection, a wireless communications device performs decision-making by evaluating the transform coefficients produced by the FHT algorithm. After processing the received sequence (through steps such as rate-dematching, de-interleaving, and soft decoding), the device applies the FHT to obtain a set of coefficients, each corresponding to a candidate codepoint. The device then compares these coefficients and selects the codepoint associated with the maximum value as the most probable transmitted sequence. If the selected codepoint matches the device's assigned identifier, the device initiates the appropriate wake-up response or further communication actions. This decision-making process ensures efficient and accurate identification of LP-WUS signals, leveraging the computational advantages of the FHT to support reliable operation in low-power wireless communication scenarios.

As indicated above, FIGS. 3A and 3B are provided as examples. Other examples may differ from what is described with respect to FIGS. 3A and 3B.

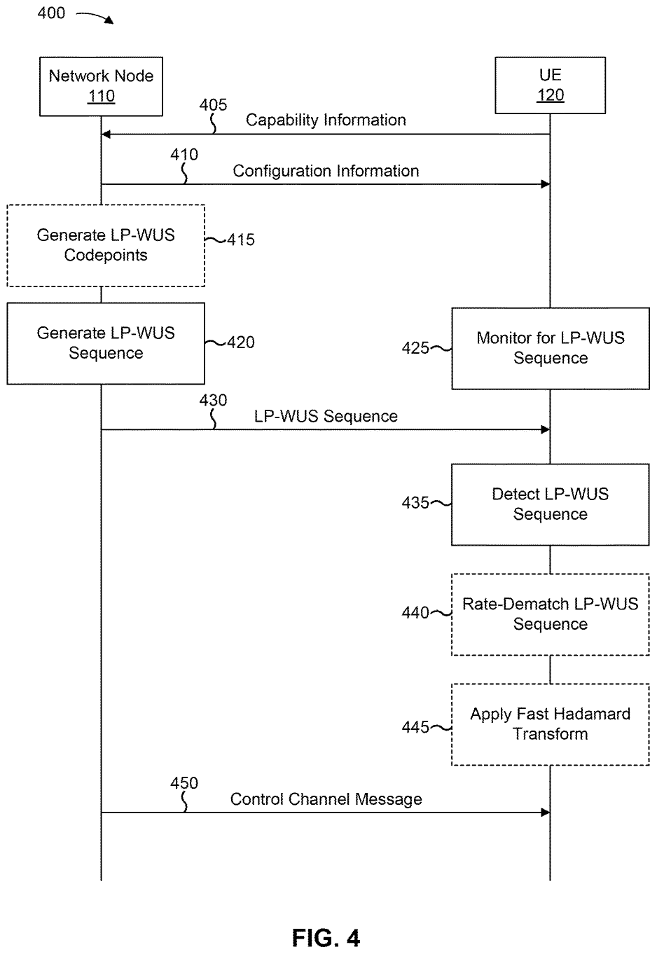

FIG. 4 is a diagram of an example 400 associated with codepoint design for LP-WUSs. As shown in FIG. 4, a network node 110 (e.g., a base station, a CU, a DU, or an RU) may communicate with a UE 120. In some aspects, the network node 110 and the UE 120 may be part of a wireless network (e.g., the wireless communication network 100). The UE 120 and the network node 110 may have established a wireless connection prior to operations shown in FIG. 4. FIG. 4 depicts an example sequence of operations associated with the transmission and reception of capability information and/or configuration information to enable efficient multiplexing and detection of LP-WUS between the network node 110 and the UE 120, where the network node 110 generates and transmits multiplexed LP-WUS codepoints using generator matrices to maintain a minimum Hamming distance, and the UE 120 monitors, detects, rate-dematches, and processes these sequences using techniques such as the fast Hadamard transform to optimize wake-up accuracy and system efficiency.

In some aspects, as shown by reference number 405, the UE 120 may transmit capability information. The capability information may be included in a capability report. The UE 120 may transmit the capability information via an uplink communication, a sidelink communication, a unicast communication, a broadcast communication, a UE assistance information (UAI) communication, an uplink control information (UCI) communication, a sidelink control information (SCI) communication, a MAC control element (MAC-CE) communication, an RRC communication, a physical uplink control channel (PUCCH), a physical uplink shared channel (PUSCH), a physical sidelink control channel (PSCCH), or a physical sidelink shared channel (PSSCH), among other examples. The capability information may indicate one or more parameters associated with respective capabilities of the UE 120. The one or more parameters may be indicated via respective information elements (IEs) included in a capability report.

The capability information may indicate whether the UE 120 supports a feature or one or more parameters related to the feature. For example, the capability information may indicate a capability or parameter for encoding procedures based on sequence length, particularly whether the sequence length, L, is a power of two or not, as this affects the encoding input and method. As another example, the capability information may indicate a capability or parameter for processing sequences using an FHT to reduce computational complexity during detection while maintaining accuracy. One or more operations described herein may be based on capability information. For example, the UE 120 may perform a communication in accordance with the capability information, or may receive configuration information that is in accordance with the capability information. In some aspects, the capability information may indicate UE support for encoding procedures based on sequence length, processing sequences using FHT, employing Maximum Likelihood detection when correlation-based detection is not feasible, and utilizing generator matrices for codepoint generation and multiplexing.

As shown by reference number 410, the network node 110 may transmit, and the UE 120 may receive, configuration information. In some aspects, the UE 120 may receive the configuration information via one or more of system information signaling (e.g., a master information block (MIB) or a system information block (SIB), among other examples), RRC signaling, MAC signaling (e.g., one or more MAC-CEs), or physical layer signaling (e.g., DCI), among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may select a candidate configuration or communication parameter from the one or more candidate configurations or communication parameters. In some aspects, the subsequent indication may include a dynamic indication, such as one or more MAC CEs or one or more DCI messages, among other examples.

In some aspects, the configuration information may include an indication of a selection of one or more configuration parameters (e.g., a selection of the one or more configuration parameters already known to the UE 120 or previously indicated by the network node or other network device), or explicit configuration information for the UE 120 to use to configure the UE 120, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may indicate that the UE 120 is to monitor for an LP-WUS sequence, which involves detecting a plurality of multiplexed LP-WUS codepoints that are rate-matched according to a minimum Hamming distance, a function of the length of the LP-WUS sequence. The UE may utilize a correlation-based detection scheme, ensuring that the minimum Hamming distance is maintained at least half the length of the LP-WUS sequence, thereby optimizing wake-up accuracy. Additionally, the UE may apply a fast Hadamard transform to the rate-dematched LP-WUS sequence, reducing computational complexity while maintaining detection accuracy. This approach allows the UE to efficiently process wake-up signals and react only to relevant ones, conserving power and enhancing overall system performance.

The UE 120 may configure itself based at least in part on the configuration information. In some aspects, the UE 120 may be configured to perform one or more operations described herein based at least in part on the configuration information.

In some aspects, the encoding procedure for the LP-WUS sequence may be distinguished based on whether the sequence length, L, is a power of two or not. For example, if L is not a power of two, the encoding input is prefixed with a zero, such that the input bits b0b1 . . . bk−1 become 0b0b1 . . . bk−1; whereas if L is a power of two, the input is simply b0b1 . . . bk, and the bits are encoded. This distinction in encoding procedures ensures compatibility with sequence length requirements and standardized encoding methods.

In some aspects, the UE may use an FHT to process the rate-dematched LP-WUS sequence during detection. For example, after rate-dematching, the UE may apply the FHT to efficiently identify the presence of the wake-up signal. Utilizing the FHT allows the UE to reduce computational complexity while maintaining accurate LP-WUS detection.

In some aspects, an alternative detection strategy may be used when rate matching does not preserve a minimum Hamming distance of at least half the sequence length. For example, in cases where correlation-based detection is not feasible due to insufficient Hamming distance, the UE detector may employ Maximum Likelihood (ML) detection to identify the LP-WUS sequence. Maximum Likelihood detection, while more complex, enables reliable signal detection under challenging encoding conditions.

In some aspects, as shown by reference number 415, the network node 110 may generate each codepoint of the plurality of multiplexed LP-WUS codepoints by multiplying each of a set of binary vectors of a length, k by a generator matrix, of the set of generator matrices, having dimensions k×L, to obtain a set of 2k codepoints each having a length, L. For example, the network node 110 may use a generator matrix that is specifically designed for k=4, resulting in 16 codepoints for certain lengths such as 12, 14, and 29. In this way, generating codepoints using a generator matrix may allow for efficient multiplexing of low-power wake-up signals.

In constructing a generator matrix for codepoint design, for each value of k (where k is the number of information bits), the process begins by generating all possible non-zero binary vectors of length k. These vectors are assembled as rows to create a matrix of dimension (2\hat{ }k−1)×k, omitting any all-zero row since such rows do not contribute to the minimum Hamming distance. For a desired sequence length L, the matrix is then adjusted by selecting and, if necessary, reordering columns and rows to ensure that the minimum Hamming distance between any two generated codepoints is at least half of L. This may involve swapping columns or rows, or moving certain sequence lengths to lower k values if the criteria cannot be satisfied. For powers of two (L=2\hat{ }m), an additional column of ones may be appended to the matrix, and for other lengths, a zero is prepended to the input vector prior to encoding.

To perform rate-matching and bit selection, a rate-matching pattern is defined for each L, specifying which indices from the encoded output are to be selected for the final codepoint. The rate-matching pattern is an L×1 vector: for each element i (0≤i<L), the value j indicates that the i^{th} bit in the output codepoint is assigned the value of the jth bit in the raw encoded bits. When multiple rows or columns yield duplicate vectors, only one instance is retained, and all-zero vectors are excluded, to maximize Hamming distance and codepoint diversity. For Reed-Muller encoding, bit selection is performed by specifying a Tk vector containing the indices of the rows to be selected from the generator matrix for a given k and L, skipping column 0 and appending a predefined value for powers of two.

By following these steps (generation of non-zero binary vectors, construction and adjustment of generator matrices, definition and application of rate-matching patterns, and careful elimination of duplicate or all-zero rows), a skilled artisan can construct codepoint sets that satisfy the minimum Hamming distance criteria for correlation-based detection, and implement the full encoding and multiplexing scheme disclosed herein for LP-WUS codepoint design.

In some aspects, when constructing generator matrices for codepoint generation, duplicate row vectors and all-zero rows are removed from the matrix prior to encoding. This process ensures that each row in the generator matrix represents a unique binary vector, thereby maximizing the minimum Hamming distance between resulting codepoints. Specifically, for any sequence length or bit selection, the generator matrix is first populated with all possible binary vectors of length k (excluding the all-zero vector), and any duplicate vectors are eliminated so that only one representative of each distinct vector remains. The removal of all-zero rows is performed because such rows do not contribute to the minimum Hamming distance or the encoding diversity required for robust wake-up signal detection. This rate-matching procedure results in codepoints that are optimally separated and minimizes wasted encoded bits, leading to improved detection performance and reduced false wake-ups.

In some aspects, the selection of the LP-WUS sequence length is determined based on a combination of factors, including the number of UEs to be woken up and system performance targets such as false alarm rates and noise thresholds. A longer sequence length may be selected to reduce the probability of false wake-ups caused by noise, as increased sequence length improves detection accuracy and lowers the false alarm rate. Conversely, the quantity of codepoints required to address the desired number of UEs also influences the minimum sequence length, ensuring that enough unique codepoints exist with sufficient Hamming distance. Thus, the network node dynamically selects the LP-WUS sequence length by balancing UE multiplexing requirements and environmental noise or quality of service targets, adapting sequence parameters to optimize both power efficiency and reliability.

In some aspects, the multiplexed LP-WUS codepoints may be encoded to wake up a subset of UEs of a set of UEs that are each monitoring for the LP-WUS sequence during the monitoring occasion. For example, the network node 110 may assign certain codepoints to specific UEs, ensuring only targeted UEs respond during the monitoring occasion. Encoding codepoints for targeted wake-up can minimize unnecessary UE 120 activations.

In some aspects, each codepoint of the plurality of multiplexed LP-WUS codepoints may be generated by multiplying each of a set of binary vectors of a length, k by a generator matrix, of the set of generator matrices, having dimensions k×L, to obtain a set of 2k codepoints each having a length, L. For example, a generator matrix for k=3 may be used to generate eight codepoints for sequence lengths such as 6, 7, or 25. Using generator matrices to generate codepoints allows for scalable codepoint sets.

In some aspects, each generator matrix of the set of generator matrices may include a plurality of non-zero binary vectors according to a selected length of the LP-WUS sequence. For example, for L=12, the generator matrix may be constructed with non-zero binary vectors to ensure robust coding. Including non-zero binary vectors supports reliable encoding for variable sequence lengths.

In some aspects, the set of generator matrices may be generated by omitting at least one all-zero row from each generator matrix of the set of generator matrices. For example, when constructing generator matrices, the network node 110 may exclude all-zero rows to maintain diversity and coding efficiency. Omitting all-zero rows can enhance codepoint separation and minimize overlap.

In some aspects, the set of generator matrices may include a quantity of matrices. For example, the design may provide multiple generator matrices for different values of k and L. Having multiple generator matrices enables flexible codepoint generation for various scenarios.

In some aspects, each generator matrix of the set of generator matrices may have a first dimension, 2k−1, and a second dimension, k, and a value of 2k corresponds to a quantity of LP-WUS codepoints in the plurality of multiplexed LP-WUS codepoints. For example, a generator matrix for k=4 may have 15 rows and 4 columns, providing 16 codepoints. Dimensions aligned with codepoint quantity facilitate efficient matrix-based encoding.

In some aspects, each codepoint of the plurality of multiplexed LP-WUS codepoints may be generated according to a selected generator matrix of the set of generator matrices that corresponds to the length of the LP-WUS sequence. For example, the network node 110 may select a generator matrix for L=22 to generate codepoints compatible with the sequence length. Selecting generator matrices based on sequence length ensures proper encoding and decoding.

In some aspects, one or more columns of each generator matrix of the set of generator matrices may be swapped with one or more other columns of the corresponding generator matrix to satisfy the minimum Hamming distance for each of a plurality of sequence lengths to generate the set of generator matrices. For example, the network node 110 may rearrange columns in a generator matrix to improve Hamming distance for L=23. Swapping columns helps achieve optimal codepoint separation for correlation-based detection.

In some aspects, the set of generator matrices may be selected to correspond to a quantity of encoded bits in the LP-WUS sequence. For example, for a sequence carrying four information bits, the generator matrix may be chosen to match the required bit quantity. Correspondence between matrix selection and encoded bits allows for precise information delivery.

In some aspects, the plurality of multiplexed LP-WUS codepoints may be generated according to a bit selection scheme and using a subset of a Reed Muller encoding table, and each entry of the subset of the Reed Muller encoding table may be prefixed with a zero. For example, the network node 110 may select entries from the Reed Muller table for L≠32 and prefix each with a zero to conform to encoding rules. Prefixed entries support consistent codepoint generation across sequence lengths.

In some aspects, the Reed Muller encoding scheme may include a plurality of generator vectors, and a quantity of LP-WUS codepoints in the plurality of multiplexed LP-WUS codepoints may be associated with a selected length of the LP-WUS sequence. For example, the network node 110 may use generator vectors for L=30 to generate 32 codepoints. Linking generator vectors to sequence length facilitates scalable encoding in the Reed Muller framework.

In some aspects, each generator vector of the plurality of generator vectors may correspond to a selected length of the LP-WUS sequence. For example, a generator vector may be matched to L=17 to produce codepoints with desired properties. Sequence-length correspondence of generator vectors enhances encoding flexibility.

In some aspects, each generator vector of the plurality of generator vectors may have a length of 2k−1. For example, for k=4, each generator vector may have a length of 15. Specifying vector length ensures compatibility with codepoint requirements.

In some aspects, an end of each generator vector of the plurality of generator vectors may include an additional entry to rate-match the LP-WUS sequence to correspond to a sequence length that is a power of two. For example, for L=16, generator vectors may be appended with an extra entry to align with power-of-two sequence lengths. Additional entries support rate-matching for standardized sequence lengths.

In some aspects, special treatment is provided when the LP-WUS sequence length is a power of two. To preserve the minimum Hamming distance and maximize codepoint diversity, the encoding process may include appending a row of ones to the generator matrix or input vector and, in certain cases, adding zeros at the bottom of the matrix. This procedure multiplies the size of the codepoint set without diminishing the minimum Hamming distance, enabling efficient multiplexing for sequence lengths such as 16, 32, or other powers of two. The approach ensures that the codepoint set maintains robust separation and detection properties, distinguishing it from encoding schemes used for non-power-of-two lengths.

In some aspects, as shown by reference number 420, the network node 110 may generate an LP-WUS sequence including a plurality of multiplexed LP-WUS codepoints that are rate-matched according to a minimum Hamming distance that is a function of a length of the LP-WUS sequence. For example, the network node 110 may ensure that the minimum Hamming distance is at least half the length of the codepoints, allowing correlation-based detectors to function effectively. In this way, rate-matching according to the minimum Hamming distance may enhance the reliability of LP-WUS detection.

In some aspects, rate-matching is performed in a manner that specifically preserves or maximizes the minimum Hamming distance between codepoints. Rather than arbitrarily assigning positions or mapping bits during the rate-matching process, the procedure involves evaluating whether each candidate rate-matching pattern or codepoint set satisfies the required Hamming distance criterion. If the rate-matching operation introduces duplicate codepoints or reduces separation below the minimum threshold, adjustments are made (such as swapping matrix columns, reordering rows, or removing non-contributing vectors) until the set of codepoints for the selected sequence length meets or exceeds the minimum Hamming distance. This results in a “smart” rate-matching approach that optimizes codepoint selection for robust, low-complexity wake-up detection.

In some aspects, each codepoint of the plurality of multiplexed LP-WUS codepoints may be rate-matched to the length of the LP-WUS sequence in accordance with the minimum Hamming distance. For example, the network node 110 may apply a rate-matching pattern to ensure the codepoints match the required sequence length and maintain the specified Hamming distance. Rate-matching by minimum Hamming distance supports robust correlation-based detection.

In some aspects, the LP-WUS sequence may be rate-matched to correspond to a sequence length that is not a power of two, and an input used to determine the plurality of generator vectors includes a zero at a beginning of the input. For example, for L=23, the input to the generator matrix may start with a zero to facilitate encoding for non-power-of-two lengths. Zero-prefixed inputs support flexible encoding for diverse sequence lengths.

In some aspects, the length of the LP-WUS sequence may be selected in accordance with at least one of a false alarm rate, a noise threshold, or a quality of service threshold. For example, the network node 110 may choose L=14 based on desired false alarm performance and noise tolerance. Selecting sequence length by system thresholds optimizes wake-up accuracy.

In some aspects, generating the LP-WUS sequence may comprise generating, according to a correlation-based detection scheme, the LP-WUS sequence, wherein the minimum Hamming distance is at least half the length of the LP-WUS sequence in accordance with the correlation-based detection scheme. For example, the network node 110 may apply a correlation-based scheme to ensure that codepoints are sufficiently separated for reliable detection. Using correlation-based detection supports efficient and accurate wake-up signal processing.

In some aspects, each codepoint of the plurality of multiplexed LP-WUS codepoints may be rate-matched to the length of the LP-WUS sequence in accordance with the minimum Hamming distance. For example, the network node 110 may use rate-matching techniques to adjust codepoint length while preserving the Hamming distance requirement. Rate-matching helps maintain detection integrity.

In some aspects, a quantity of the plurality of multiplexed LP-WUS codepoints may correspond to a set of LP-WUS sequence lengths. For example, the network node 110 may select a codepoint set size based on available sequence lengths such as 14, 16, and 18. Correspondence between codepoint quantity and sequence length enables flexible multiplexing.

In some aspects, the length of the LP-WUS sequence may be selected from the set of LP-WUS sequence lengths corresponding to the quantity of the plurality of multiplexed LP-WUS codepoints. For example, L may be chosen as 16 from a set of available lengths based on multiplexing needs. Selecting sequence length from an available set supports efficient codepoint allocation.

In some aspects, the length of the LP-WUS sequence may be equal to a power, m, of a base of 2, and the quantity of the plurality of multiplexed LP-WUS codepoints may be equal to 2m+1. For example, for m=4, L=16, and there may be 17 codepoints. Power-of-two sequence lengths and codepoint quantities support structured encoding and decoding.

In some aspects, the length of the LP-WUS sequence may be selected in accordance with at least one of a false alarm rate, a noise threshold, or a quality of service threshold. For example, L may be selected as 20 based on quality-of-service requirements. Sequence length selection by performance threshold ensures system reliability.

In some aspects, codepoint generation may be alternatively defined by a bit selection and reordering process based on the properties of the generator matrix or Reed Muller encoding table. For a given input vector, the encoding process involves selecting rows or columns from the generator matrix according to a predefined bit selection vector (π), which may be constructed to guarantee all possible k-bit binary combinations are represented. The bit selection vector determines which rows from the generator matrix are used and how the resulting encoded bits are reordered to form the final codepoint. In cases where multiple equivalent rows exist (i.e., produce the same encoded result for a given k), only one representative row is selected to avoid redundancy. This flexible definition allows for codepoint sets that maintain the minimum Hamming distance criterion and supports sequence lengths that are both powers of two and non-powers of two.

In some aspects, as shown by reference number 425, the UE 120 may monitor for, during a monitoring occasion, an LP-WUS sequence including a plurality of multiplexed LP-WUS codepoints that are rate-matched according to a minimum Hamming distance that is a function of a length of the LP-WUS sequence. For example, the UE 120 may monitor for LP-WUS sequences where the codepoints are designed to wake up only the intended UEs, using codepoints with a sufficient Hamming distance to minimize false wake-ups. In this way, monitoring for LP-WUS sequences may help conserve UE 120 power by reducing unnecessary wake-ups.

In some aspects, as shown by reference number 430, the network node 110 may transmit, during a monitoring occasion associated with the UE 120, the LP-WUS sequence, wherein each codepoint of the plurality of multiplexed LP-WUS codepoints is generated according to a set of generator matrices that are associated with the minimum Hamming distance. For example, the network node 110 may select generator matrices that ensure the minimum Hamming distance is maintained across the transmitted codepoints, supporting efficient and accurate LP-WUS delivery. In this way, transmitting LP-WUS sequences with appropriate generator matrices may improve wake-up accuracy and system efficiency.

In some aspects, the multiplexed LP-WUS codepoints may be encoded to wake up a subset of UEs of a set of UEs that are each monitoring for the LP-WUS sequence during the monitoring occasion. For example, codepoints may be designed for selective UE 120 wake-up, avoiding unnecessary activations. Targeted encoding supports efficient system operation.

In some aspects, the LP-WUS sequence may be generated according to a correlation-based detection scheme, wherein the minimum Hamming distance is at least half the length of the LP-WUS sequence in accordance with the correlation-based detection scheme. For example, correlation-based generation may ensure reliable detector performance. Correlation-based schemes optimize wake-up accuracy.

In some aspects, the set of generator matrices may be generated by omitting at least one all-zero row from each generator matrix of the set of generator matrices. For example, matrices may exclude all-zero rows to boost codepoint diversity. Omitting all-zero rows improves codepoint discrimination.

In some aspects, the set of generator matrices may include a quantity of matrices. For example, different matrices may be used for different sequence lengths. Multiple matrices support flexible codepoint generation.

In some aspects, each generator matrix of the set of generator matrices may have a first dimension, 2k−1 and a second dimension, k, and a value of 2k may correspond to a quantity of LP-WUS codepoints in the plurality of multiplexed LP-WUS codepoints. For example, for k=3, the matrix may have 7 rows and 3 columns yielding 8 codepoints. Dimensioning matrices to codepoint quantity supports scalable encoding.

In some aspects, each codepoint of the plurality of multiplexed LP-WUS codepoints may be generated according to a selected generator matrix of the set of generator matrices that corresponds to the length of the LP-WUS sequence. For example, a matrix for L=14 may be selected to generate compatible codepoints. Selecting matrices by sequence length ensures robust encoding.

In some aspects, one or more columns of each generator matrix of the set of generator matrices may be swapped with one or more other columns of the corresponding generator matrix to satisfy the minimum Hamming distance for each of a plurality of sequence lengths to generate the set of generator matrices. For example, swapping columns for L=29 may improve Hamming distance. Column swapping facilitates optimal codepoint separation.

In some aspects, as shown by reference number 435, the UE 120 may detect the LP-WUS sequence to obtain an LP-WUS associated with the UE, wherein each codepoint of the plurality of multiplexed LP-WUS codepoints is generated according to a set of generator matrices that are associated with the minimum Hamming distance. For example, the UE 120 may use detection techniques that leverage the structured codepoints to minimize false positives. In this way, detecting LP-WUS sequences may ensure that the UE 120 wakes up only for relevant signals, thereby optimizing battery life.

In some aspects, the multiplexed LP-WUS codepoints may be encoded to wake up a subset of UEs of a set of UEs that are each monitoring for the LP-WUS sequence during the monitoring occasion. For example, the UE 120 may respond only to its assigned codepoint, ignoring other signals. Encoding for subset wake-up reduces power consumption.

In some aspects, detecting the LP-WUS sequence may comprise detecting, according to correlation-based detection, the LP-WUS sequence, wherein the minimum Hamming distance is at least half the length of the LP-WUS sequence in accordance with the correlation-based detection. For example, the UE 120 may use a correlation-based detector and confirm the minimum Hamming distance for reliable wake-up. Correlation-based detection enables efficient and low-complexity signal processing.

In some aspects, each codepoint of the plurality of multiplexed LP-WUS codepoints may be rate-matched to the length of the LP-WUS sequence in accordance with the minimum Hamming distance. For example, the UE 120 may apply a rate-matching algorithm to align detected codepoints with the expected length and Hamming distance. Rate-matching supports robust detection and error minimization.

In some aspects, a quantity of the plurality of multiplexed LP-WUS codepoints may correspond to a set of LP-WUS sequence lengths. For example, the UE 120 may track sequence lengths to identify codepoint sets. Sequence length correspondence facilitates accurate codepoint mapping.

In some aspects, the length of the LP-WUS sequence may be selected from the set of LP-WUS sequence lengths corresponding to the quantity of the plurality of multiplexed LP-WUS codepoints. For example, the UE 120 may determine L=18 from available sequence lengths. Selecting sequence length from set ensures compatibility with codepoint structure.

In some aspects, the length of the LP-WUS sequence may be equal to a power, m, of a base of 2, and the quantity of the plurality of multiplexed LP-WUS codepoints may be equal to 2m+1. For example, the UE 120 may recognize L=8 and a codepoint quantity of 9. Power-of-two sequence lengths with matching codepoint quantity support structured wake-up detection.

In some aspects, the length of the LP-WUS sequence may be selected in accordance with at least one of a false alarm rate, a noise threshold, or a quality of service threshold. For example, the UE 120 may select L based on network signal quality parameters. Sequence length selection by quality metrics optimizes performance.

In some aspects, as shown by reference number 440, the UE 120 may rate-dematch the LP-WUS sequence. For example, the UE 120 could apply a rate-dematching process that aligns with the original encoding rules to reconstruct the transmitted codepoints accurately. In this way, rate-dematching the LP-WUS sequence may facilitate accurate signal interpretation and reliable wake-up signaling.

In some aspects, rate-dematching the LP-WUS sequence may include rate-matching each codepoint to the length of the LP-WUS sequence in accordance with the minimum Hamming distance. For example, the UE 120 may adjust codepoint structure to align with the expected sequence length and Hamming distance. Rate-dematching maintains detection accuracy for variable sequence lengths.

In some aspects, rate-dematching the LP-WUS sequence may include rate-matching the LP-WUS sequence to correspond to a sequence length that is not a power of two, and an input used to determine the plurality of generator vectors includes a zero at a beginning of the input. For example, the UE 120 may recognize non-power-of-two lengths and apply zero-prefixed inputs during rate-dematching. Rate-dematching for non-standard sequence lengths supports flexible encoding and decoding.

In some aspects, as shown by reference number 445, the UE 120 may apply a fast Hadamard transform to the rate-dematched LP-WUS sequence. For example, the UE 120 may perform a fast Hadamard transform to efficiently process the codepoints for detection decisions. In this way, applying a fast Hadamard transform may reduce computational complexity while maintaining detection accuracy.

In some aspects, as shown by reference number 450, the UE 120 may receive a control channel message in association with detecting the LP-WUS sequence. For example, upon successful detection of the LP-WUS sequence, the UE 120 may receive further instructions or updates via a control channel message. In this way, receiving a control channel message may ensure that the UE 120 is synchronized with network operations and configurations.

As indicated above, FIG. 4 is provided as an example. Other examples may differ from what is described with regard to FIG. 4.

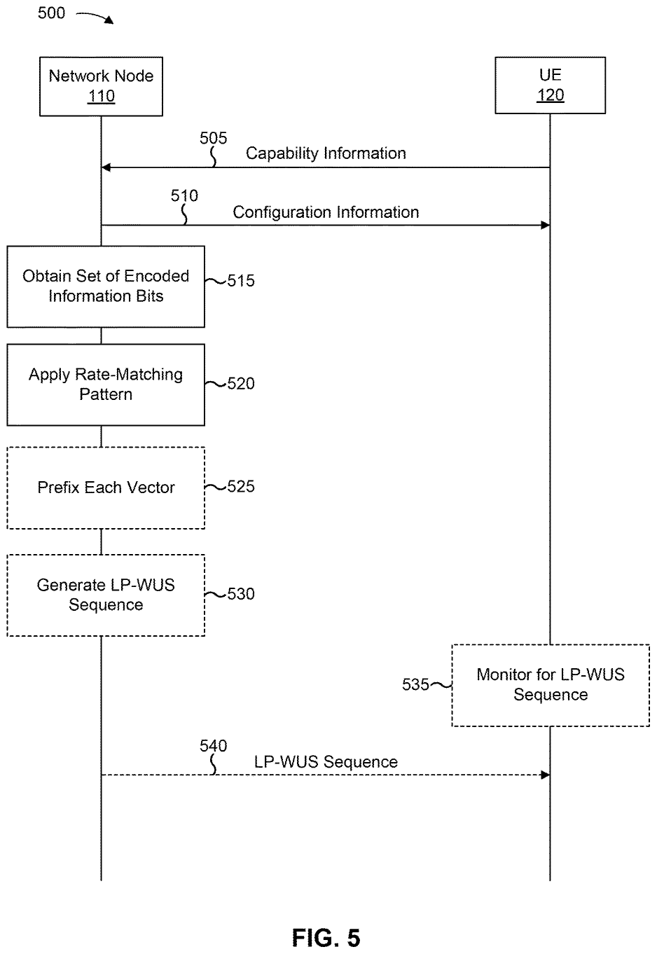

FIG. 5 is a diagram of an example 500 associated with codepoint design for low-power wake-up signals. As shown in FIG. 5, a network node 110 (e.g., a base station, a CU, a DU, or an RU) may communicate with a UE 120. In some aspects, the network node 110 and the UE 120 may be part of a wireless network (e.g., the wireless communication network 100). The UE 120 and the network node 110 may have established a wireless connection prior to operations shown in FIG. 5. FIG. 5 depicts an example sequence of operations associated with the transmission and reception of capability information and/or configuration information to enable the effective use of LP-WUS between a network node 110 and a UE 120, facilitating efficient signaling, robust communication, and optimized wake-up processes through the exchange of capability and configuration data, encoding techniques, and transmission of multiplexed codepoints.

In some aspects, as shown by reference number 505, the UE 120 may transmit capability information. The capability information may be included in a capability report. The UE 120 may transmit the capability information via an uplink communication, a sidelink communication, a unicast communication, a broadcast communication, a UE assistance information (UAI) communication, an uplink control information (UCI) communication, a sidelink control information (SCI) communication, a MAC control element (MAC-CE) communication, an RRC communication, a physical uplink control channel (PUCCH), a physical uplink shared channel (PUSCH), a physical sidelink control channel (PSCCH), or a physical sidelink shared channel (PSSCH), among other examples. The capability information may indicate one or more parameters associated with respective capabilities of the UE 120. The one or more parameters may be indicated via respective information elements (IEs) included in a capability report.

The capability information may indicate whether the UE 120 supports a feature or one or more parameters related to the feature. For example, the capability information may indicate a capability or parameter for supporting specific LP-WUS configurations. As another example, the capability information may indicate a capability or parameter for multiplexing of LP-WUS codepoints to wake up specific UEs while avoiding unintended wake-ups. One or more operations described herein may be based on capability information. For example, the UE 120 may perform a communication in accordance with the capability information, or may receive configuration information that is in accordance with the capability information. In some aspects, the capability information may indicate UE support for detailed procedures for generating LP-WUS codepoints, a plurality of proposals for Reed Muller (RM)-based codepoint design, obtaining a set of encoded information bits using a set of generator vectors, applying a rate-matching pattern to the set of encoded information bits to generate a low-power wake-up signal sequence, and prefixing each vector with a zero value for sequences not a power of two.

In some aspects, the UE 120 may transmit data indicating its ability to support specific LP-WUS configurations to the network node 110, or the network node 110 may transmit data indicating its ability to support specific LP-WUS configurations to the UE 120. In this way, transmitting capability information may enable the UE 120 and the network node 110 to understand and utilize supported features effectively.

In some aspects, multiplexing of LP-WUS codepoints may be employed to wake up specific UEs while avoiding unintended wake-ups. For example, the network node 110 may assign each UE to monitor one or more codepoints, and on a given monitoring occasion, may design a set of codepoints such that only the targeted UEs wake up if their respective codepoint is detected, while other UEs do not. Ensuring a minimum Hamming distance of at least half the codepoint length between codepoints may reduce the likelihood of unintended wake-ups and improve selectivity for correlation-based detectors.

As shown by reference number 510, the network node 110 may transmit, and the UE 120 may receive, configuration information. In some aspects, the UE 120 may receive the configuration information via one or more of system information signaling (e.g., a master information block (MIB) or a system information block (SIB), among other examples), RRC signaling, MAC signaling (e.g., one or more MAC-CEs), or physical layer signaling (e.g., DCI), among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may select a candidate configuration or communication parameter from the one or more candidate configurations or communication parameters. In some aspects, the subsequent indication may include a dynamic indication, such as one or more MAC CEs or one or more DCI messages, among other examples.

In some aspects, the configuration information may include an indication of a selection of one or more configuration parameters (e.g., a selection of the one or more configuration parameters already known to the UE 120 or previously indicated by the network node or other network device), or explicit configuration information for the UE 120 to use to configure the UE 120, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may indicate that the UE 120 is to monitor and decode LP-WUSs by utilizing specific codepoint sets assigned by the network node. The UE may be required to interpret these codepoints based on parameters provided in the configuration information, ensuring that it can effectively recognize the signals intended for it. This allows the UE to manage power efficiently by waking up only when necessary, thereby optimizing its operations and maintaining seamless connectivity with the network.

The UE 120 may configure itself based at least in part on the configuration information. In some aspects, the UE 120 may be configured to perform one or more operations described herein based at least in part on the configuration information.

In some aspects, the network node 110 may provide the UE 120 with parameters required for decoding the LP-WUS, such as the specific codepoint set to monitor. In this way, transmitting configuration information may ensure that the UE 120 can accurately interpret the LP-WUS signals intended for the UE 120.

In some aspects, detailed procedures for generating LP-WUS codepoints may include using an RM encoder and appending a zero bit when the sequence length, L is not a power of two. For example, when L is not a power of two, the network node 110 may take an input sequence b0b1 . . . bk−1 and prepend a zero to form 0b0b1 . . . bk−1, then encode and apply a rate matching pattern to produce output encoded bits. Alternatively, for other cases, the network node 110 may define per L a length 2\hat{ }k−1 vector, append a zero for non-power-of-two lengths, or append a predefined value, such as 31, at the end for power-of-two lengths, followed by encoding and rate matching. This procedure enables flexible generation of codepoints compatible with varying sequence lengths and encoding requirements.

In some aspects, a plurality of proposals for RM-based codepoint design may be employed, including the use of different generator matrices, bit selection patterns, and potentially multiple matrices for a given k if design criteria cannot be met with a single matrix. For example, the network node 110 may build a sequence set as (k, n) FEC encoders that result in 2\hat{ }k length n sequences, check for each L that the generated sequence set and rate matched sequences uphold the minimum Hamming distance criteria, and if not, use more than one matrix for a given k. Alternatively, the codepoint generation may be using an Reed-Muller encoder and varied bit selection approaches. These proposals may allow for optimized codepoint sets that meet the stringent design requirements for robust wake-up signaling.

In some aspects, as shown by reference number 515, the network node 110 may obtain a set of encoded information bits using a set of generator vectors. For example, the network node 110 may use Reed-Muller encoding techniques to form a sequence of bits that can be effectively decoded by a UE 120. In this way, obtaining a set of encoded information bits may facilitate robust communication by enhancing error detection capabilities.

In some aspects, as shown by reference number 520, the network node 110 may apply a rate-matching pattern to the set of encoded information bits to generate a LP-WUS sequence including a plurality of multiplexed LP-WUS codepoints, wherein the rate-matching pattern is a function of a length of the LP-WUS sequence. For example, the network node 110 may adjust the bit sequence based on its length to meet specific Hamming distance requirements, ensuring reliable wake-up signaling. In this way, applying a rate-matching pattern may optimize the wake-up process by reducing false alarms and ensuring energy efficiency.

Additionally, or alternatively, the rate-matching pattern may include a vector having a first dimension, L, and a second dimension, 1. For example, the network node 110 may select a rate-matching pattern that is an L×1 vector, where L is the sequence length, and each entry maps directly to the encoded information bits. A vector with defined dimensions may facilitate precise bit selection for rate-matching.

Additionally, or alternatively, an i^{th} entry in the rate-matching pattern may have a value, j, and an i^{th} entry in the LP-WUS sequence may have a same value as a j^{th} entry in the set of encoded information bits. For example, the network node 110 may configure the rate-matching pattern so that each index in the output sequence directly references the corresponding value from the encoded information bits. This mapping may ensure efficient and accurate rate-matching of the LP-WUS sequence.

In some aspects, as shown by reference number 525, the network node 110 may prefix each vector with a zero value, wherein the length of the LP-WUS sequence is not a power of two. For example, if the length is 22, the network node 110 may prepend a zero to the codepoint vectors to stabilize the encoding process. In this way, prefixing each vector with a zero value may ensure compatibility with the encoding system for non-standard sequence lengths.

In some aspects, as shown by reference number 530, the network node 110 may generate the LP-WUS sequence. For example, the network node 110 may compile encoded bits into a defined sequence that can be readily detected by UEs. In this way, generating the LP-WUS sequence may enable efficient and targeted wake-up signaling for UEs.

In some aspects, as shown by reference number 535, the UE 120 may monitor for the LP-WUS sequence. For example, the UE 120 may scan for incoming LP-WUS signals to ensure seamless communication initiation with the network node 110.

In some aspects, as shown by reference number 540, the network node 110 may transmit, and the UE 120 may receive, the LP-WUS sequence. For example, the network node 110 could broadcast the sequence at scheduled intervals to wake up target UEs without disturbing others. In this way, transmitting the LP-WUS sequence may facilitate efficient network operations by minimizing unnecessary power usage and maximizing communication precision.

As indicated above, FIG. 5 is provided as an example. Other examples may differ from what is described with regard to FIG. 5.

FIG. 6 is a diagram illustrating an example process 600 performed, for example, at a UE or an apparatus of a UE. Example process 600 is an example where the apparatus or the UE (e.g., UE 120) performs operations associated with codepoint design for low-power wake-up signals.

As shown in FIG. 6, in some aspects, process 600 may include monitoring for, during a monitoring occasion, an LP-WUS sequence including a plurality of multiplexed LP-WUS codepoints that are rate-matched according to a minimum Hamming distance that is a function of a length of the LP-WUS sequence (block 610). For example, the UE (e.g., using communication manager 1106, depicted in FIG. 11) may monitor for, during a monitoring occasion, an LP-WUS sequence including a plurality of multiplexed LP-WUS codepoints that are rate-matched according to a minimum Hamming distance that is a function of a length of the LP-WUS sequence, as described above.

As further shown in FIG. 6, in some aspects, process 600 may include detecting the LP-WUS sequence to obtain an LP-WUS associated with the UE, wherein each codepoint of the plurality of multiplexed LP-WUS codepoints is generated according to a set of generator matrices that are associated with the minimum Hamming distance (block 620). For example, the UE (e.g., using communication manager 1106, depicted in FIG. 11) may detect the LP-WUS sequence to obtain an LP-WUS associated with the UE, wherein each codepoint of the plurality of multiplexed LP-WUS codepoints is generated according to a set of generator matrices that are associated with the minimum Hamming distance, as described above.

As further shown in FIG. 6, in some aspects, process 600 may include receiving a control channel message in association with detecting the LP-WUS sequence (block 630). For example, the UE (e.g., using reception component 1102 or communication manager 1106, depicted in FIG. 11) may receive a control channel message in association with detecting the LP-WUS sequence, as described above.

Process 600 may include additional aspects, such as any single aspect or any combination of aspects described below or in connection with one or more other processes described elsewhere herein.

In a first aspect, detecting the LP-WUS sequence comprises rate-dematching the LP-WUS sequence, and applying a fast Hadamard transform to the rate-dematched LP-WUS sequence.

In a second aspect, alone or in combination with the first aspect, the multiplexed LP-WUS codepoints are encoded to wake up a subset of UEs of a set of UEs that are each monitoring for the LP-WUS sequence during the monitoring occasion.

In a third aspect, alone or in combination with one or more of the first and second aspects, each codepoint of the plurality of multiplexed LP-WUS codepoints is generated by multiplying each of a set of binary vectors of a length, k by a generator matrix, of the set of generator matrices, having dimensions k×L, to obtain a set of 2^{k} codepoints each having a length, L.

In a fourth aspect, alone or in combination with one or more of the first through third aspects, each generator matrix of the set of generator matrices includes a plurality of non-zero binary vectors according to a selected length of the LP-WUS sequence.

In a fifth aspect, alone or in combination with one or more of the first through fourth aspects, detecting the LP-WUS sequence comprises detecting, according to correlation-based detection, the LP-WUS sequence, wherein the minimum Hamming distance is at least half the length of the LP-WUS sequence in accordance with the correlation-based detection.

In a sixth aspect, alone or in combination with one or more of the first through fifth aspects, the set of generator matrices is generated by omitting at least one all-zero row from each generator matrix of the set of generator matrices.

In a seventh aspect, alone or in combination with one or more of the first through sixth aspects, the set of generator matrices includes a quantity of matrices.

In an eighth aspect, alone or in combination with one or more of the first through seventh aspects, each generator matrix of the set of generator matrices has a first dimension, 2^{k}−1, and a second dimension, k, and a value of 2^{k} corresponds to a quantity of LP-WUS codepoints in the plurality of multiplexed LP-WUS codepoints.

In a ninth aspect, alone or in combination with one or more of the first through eighth aspects, each codepoint of the plurality of multiplexed LP-WUS codepoints is generated according to a selected generator matrix of the set of generator matrices that corresponds to the length of the LP-WUS sequence.

In a tenth aspect, alone or in combination with one or more of the first through ninth aspects, one or more columns of each generator matrix of the set of generator matrices are swapped with one or more other columns of the corresponding generator matrix to satisfy the minimum Hamming distance for each of a plurality of sequence lengths to generate the set of generator matrices.

In an eleventh aspect, alone or in combination with one or more of the first through tenth aspects, each codepoint of the plurality of multiplexed LP-WUS codepoints is rate-matched to the length of the LP-WUS sequence in accordance with the minimum Hamming distance.

In a twelfth aspect, alone or in combination with one or more of the first through eleventh aspects, a quantity of the plurality of multiplexed LP-WUS codepoints corresponds to a set of LP-WUS sequence lengths.

In a thirteenth aspect, alone or in combination with one or more of the first through twelfth aspects, the length of the LP-WUS sequence is selected from the set of LP-WUS sequence lengths corresponding to the quantity of the plurality of multiplexed LP-WUS codepoints.

In a fourteenth aspect, alone or in combination with one or more of the first through thirteenth aspects, the length of the LP-WUS sequence is equal to a power, m, of a base of 2, and the quantity of the plurality of multiplexed LP-WUS codepoints is equal to 2m+1.

In a fifteenth aspect, alone or in combination with one or more of the first through fourteenth aspects, the length of the LP-WUS sequence is selected in accordance with at least one of a false alarm rate, a noise threshold, or a quality of service threshold.

In a sixteenth aspect, alone or in combination with one or more of the first through fifteenth aspects, the set of generator matrices is selected to correspond to a quantity of encoded bits in the LP-WUS sequence.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a UE or an apparatus of a UE. Example process 700 is an example where the apparatus or the UE (e.g., UE 120) performs operations associated with codepoint design for low-power wake-up signals.

As shown in FIG. 7, in some aspects, process 700 may include monitoring for, during a monitoring occasion, an LP-WUS sequence including a plurality of multiplexed LP-WUS codepoints that are rate-matched according to a minimum Hamming distance that is a function of a length of the LP-WUS sequence (block 710). For example, the UE (e.g., using communication manager 1106, depicted in FIG. 11) may monitor for, during a monitoring occasion, an LP-WUS sequence including a plurality of multiplexed LP-WUS codepoints that are rate-matched according to a minimum Hamming distance that is a function of a length of the LP-WUS sequence, as described above.

As further shown in FIG. 7, in some aspects, process 700 may include detecting the LP-WUS sequence to obtain an LP-WUS associated with the UE, wherein each codepoint of the plurality of multiplexed LP-WUS codepoints is generated according to a Reed Muller encoding scheme (block 720). For example, the UE (e.g., using communication manager 1106, depicted in FIG. 11) may detect the LP-WUS sequence to obtain an LP-WUS associated with the UE, wherein each codepoint of the plurality of multiplexed LP-WUS codepoints is generated according to a Reed Muller encoding scheme, as described above.

As further shown in FIG. 7, in some aspects, process 700 may include receiving a control channel message in association with detecting the LP-WUS sequence (block 730). For example, the UE (e.g., using reception component 1102 or communication manager 1106, depicted in FIG. 11) may receive a control channel message in association with detecting the LP-WUS sequence, as described above.

Process 700 may include additional aspects, such as any single aspect or any combination of aspects described below or in connection with one or more other processes described elsewhere herein.

In a first aspect, the plurality of multiplexed LP-WUS codepoints are generated according to a Reed Muller encoding table and a bit selection scheme that corresponds to the length of the LP-WUS sequence.

In a second aspect, alone or in combination with the first aspect, the Reed Muller encoding scheme includes a plurality of generator vectors, and a quantity of LP-WUS codepoints in the plurality of multiplexed LP-WUS codepoints is associated with a selected length of the LP-WUS sequence.

In a third aspect, alone or in combination with one or more of the first and second aspects, the LP-WUS sequence is rate-matched to correspond to a sequence length of a first set of sequence lengths by using an input to determine the plurality of generator vectors that includes a padded zero at a beginning of the input, or the LP-WUS sequence is rate-matched to correspond to a sequence length of a second set of sequence lengths by using an input to determine the plurality of generator vectors that does not include a padded zero at a beginning of the input.

In a fourth aspect, alone or in combination with one or more of the first through third aspects, each generator vector of the plurality of generator vectors corresponds to a selected length of the LP-WUS sequence.

In a fifth aspect, alone or in combination with one or more of the first through fourth aspects, each generator vector of the plurality of generator vectors has a length of 2^{k}−1.

In a sixth aspect, alone or in combination with one or more of the first through fifth aspects, an end of each generator vector of the plurality of generator vectors includes an additional entry to rate-match the LP-WUS sequence to correspond to a sequence length that is a power of two.

In a seventh aspect, alone or in combination with one or more of the first through sixth aspects, the length of the LP-WUS sequence is selected in accordance with at least one of a false alarm rate, a noise threshold, or a quality of service threshold.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node. Example process 800 is an example where the apparatus or the network node (e.g., network node 110) performs operations associated with codepoint design for low-power wake-up signals.

As shown in FIG. 8, in some aspects, process 800 may include generating an LP-WUS sequence including a plurality of multiplexed LP-WUS codepoints that are rate-matched according to a minimum Hamming distance that is a function of a length of the LP-WUS sequence (block 810). For example, the network node (e.g., using communication manager 1206, depicted in FIG. 12) may generate an LP-WUS sequence including a plurality of multiplexed LP-WUS codepoints that are rate-matched according to a minimum Hamming distance that is a function of a length of the LP-WUS sequence, as described above.

As further shown in FIG. 8, in some aspects, process 800 may include transmitting, during a monitoring occasion associated with a UE, the LP-WUS sequence, wherein each codepoint of the plurality of multiplexed LP-WUS codepoints is generated according to a set of generator matrices that are associated with the minimum Hamming distance (block 820). For example, the network node (e.g., using transmission component 1204 or communication manager 1206, depicted in FIG. 12) may transmit, during a monitoring occasion associated with a UE, the LP-WUS sequence, wherein each codepoint of the plurality of multiplexed LP-WUS codepoints is generated according to a set of generator matrices that are associated with the minimum Hamming distance, as described above.

As further shown in FIG. 8, in some aspects, process 800 may include transmitting a control channel message in association with transmitting the LP-WUS sequence (block 830). For example, the network node (e.g., using transmission component 1204 or communication manager 1206, depicted in FIG. 12) may transmit a control channel message in association with transmitting the LP-WUS sequence, as described above.

Process 800 may include additional aspects, such as any single aspect or any combination of aspects described below or in connection with one or more other processes described elsewhere herein.

In a first aspect, the multiplexed LP-WUS codepoints are encoded to wake up a subset of UEs of a set of UEs that are each monitoring for the LP-WUS sequence during the monitoring occasion.

In a second aspect, alone or in combination with the first aspect, process 800 includes generating each codepoint of the plurality of multiplexed LP-WUS codepoints by multiplying each of a set of binary vectors of a length, k, by a generator matrix, of the set of generator matrices, having dimensions k×L, to obtain a set of 2^{k} codepoints each having a length, L.

In a third aspect, alone or in combination with one or more of the first and second aspects, each generator matrix of the set of generator matrices includes a plurality of non-zero binary vectors according to a selected length of the LP-WUS sequence.

In a fourth aspect, alone or in combination with one or more of the first through third aspects, generating the LP-WUS sequence comprises generating, according to a correlation-based detection scheme, the LP-WUS sequence, wherein the minimum Hamming distance is at least half the length of the LP-WUS sequence in accordance with the correlation-based detection scheme.

In a fifth aspect, alone or in combination with one or more of the first through fourth aspects, the set of generator matrices is generated by omitting at least one all-zero row from each generator matrix of the set of generator matrices.

In a sixth aspect, alone or in combination with one or more of the first through fifth aspects, the set of generator matrices includes a quantity of matrices.

In a seventh aspect, alone or in combination with one or more of the first through sixth aspects, process 800 includes each generator matrix of the set of generator matrices has a first dimension, 2^{k}−1 and a second dimension, k, and a value of 2^{k} corresponds to a quantity of LP-WUS codepoints in the plurality of multiplexed LP-WUS codepoints.

In an eighth aspect, alone or in combination with one or more of the first through seventh aspects, each codepoint of the plurality of multiplexed LP-WUS codepoints is generated according to a selected generator matrix of the set of generator matrices that corresponds to the length of the LP-WUS sequence.

In a ninth aspect, alone or in combination with one or more of the first through eighth aspects, one or more columns of each generator matrix of the set of generator matrices are swapped with one or more other columns of the corresponding generator matrix to satisfy the minimum Hamming distance for each of a plurality of sequence lengths to generate the set of generator matrices.

In a tenth aspect, alone or in combination with one or more of the first through ninth aspects, each codepoint of the plurality of multiplexed LP-WUS codepoints is rate-matched to the length of the LP-WUS sequence in accordance with the minimum Hamming distance.

In an eleventh aspect, alone or in combination with one or more of the first through tenth aspects, a quantity of the plurality of multiplexed LP-WUS codepoints corresponds to a set of LP-WUS sequence lengths.

In a twelfth aspect, alone or in combination with one or more of the first through eleventh aspects, the length of the LP-WUS sequence is selected from the set of LP-WUS sequence lengths corresponding to the quantity of the plurality of multiplexed LP-WUS codepoints.

In a thirteenth aspect, alone or in combination with one or more of the first through twelfth aspects, the length of the LP-WUS sequence is equal to a power, m, of a base of 2, and the quantity of the plurality of multiplexed LP-WUS codepoints is equal to 2m+1.

In a fourteenth aspect, alone or in combination with one or more of the first through thirteenth aspects, the length of the LP-WUS sequence is selected in accordance with at least one of a false alarm rate, a noise threshold, or a quality of service threshold.

In a fifteenth aspect, alone or in combination with one or more of the first through fourteenth aspects, the set of generator matrices is selected to correspond to a quantity of encoded bits in the LP-WUS sequence.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node. Example process 900 is an example where the apparatus or the network node (e.g., network node 110) performs operations associated with codepoint design for low-power wake-up signals.

As shown in FIG. 9, in some aspects, process 900 may include generating an LP-WUS sequence including a plurality of multiplexed LP-WUS codepoints that are rate-matched according to a minimum Hamming distance that is a function of a length of the LP-WUS sequence (block 910). For example, the network node (e.g., using communication manager 1206, depicted in FIG. 12) may generate an LP-WUS sequence including a plurality of multiplexed LP-WUS codepoints that are rate-matched according to a minimum Hamming distance that is a function of a length of the LP-WUS sequence, as described above.

As further shown in FIG. 9, in some aspects, process 900 may include transmitting, during a monitoring occasion associated with a UE, the LP-WUS sequence, wherein each codepoint of the plurality of multiplexed LP-WUS codepoints is generated according to a Reed Muller encoding scheme (block 920). For example, the network node (e.g., using transmission component 1204 or communication manager 1206, depicted in FIG. 12) may transmit, during a monitoring occasion associated with a UE, the LP-WUS sequence, wherein each codepoint of the plurality of multiplexed LP-WUS codepoints is generated according to a Reed Muller encoding scheme, as described above.

As further shown in FIG. 9, in some aspects, process 900 may include transmitting a control channel message in association with transmitting the LP-WUS sequence (block 930). For example, the network node (e.g., using transmission component 1204 or communication manager 1206, depicted in FIG. 12) may transmit a control channel message in association with transmitting the LP-WUS sequence, as described above.

Process 900 may include additional aspects, such as any single aspect or any combination of aspects described below or in connection with one or more other processes described elsewhere herein.

In a first aspect, process 900 includes generating, according to a bit selection scheme that corresponds to the length of the LP-WUS sequence, the plurality of multiplexed LP-WUS codepoints using a Reed Muller encoding table.

In a second aspect, alone or in combination with the first aspect, process 900 includes the Reed Muller encoding scheme includes a plurality of generator vectors, and a quantity of LP-WUS codepoints in the plurality of multiplexed LP-WUS codepoints is associated with a selected length of the LP-WUS sequence.

In a third aspect, alone or in combination with one or more of the first and second aspects, the LP-WUS sequence is rate-matched to correspond to a sequence length of a first set of sequence lengths by using an input to determine the plurality of generator vectors that includes a padded zero at a beginning of the input, or the LP-WUS sequence is rate-matched to correspond to a sequence length of a second set of sequence lengths by using an input to determine the plurality of generator vectors that does not include a padded zero at a beginning of the input.

In a fourth aspect, alone or in combination with one or more of the first through third aspects, an end of each generator vector of the plurality of generator vectors includes an additional entry to rate-match the LP-WUS sequence to correspond to a sequence length that is a power of two.

In a fifth aspect, alone or in combination with one or more of the first through fourth aspects, the length of the LP-WUS sequence is selected in accordance with at least one of a false alarm rate, a noise threshold, or a quality of service threshold.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node. Example process 1000 is an example where the apparatus or the network node (e.g., network node 110) performs operations associated with codepoint design for low-power wake-up signals.

As shown in FIG. 10, in some aspects, process 1000 may include obtaining a set of encoded information bits using a set of generator vectors (block 1010). For example, the network node (e.g., using reception component 1202 or communication manager 1206, depicted in FIG. 12) may obtain a set of encoded information bits using a set of generator vectors, as described above.

As further shown in FIG. 10, in some aspects, process 1000 may include applying a rate-matching pattern to the set of encoded information bits to generate an LP-WUS sequence including a plurality of multiplexed LP-WUS codepoints, wherein the rate-matching pattern is a function of a length of the LP-WUS sequence (block 1020). For example, the network node (e.g., using communication manager 1206, depicted in FIG. 12) may apply a rate-matching pattern to the set of encoded information bits to generate an LP-WUS sequence including a plurality of multiplexed LP-WUS codepoints, wherein the rate-matching pattern is a function of a length of the LP-WUS sequence, as described above.

Process 1000 may include additional aspects, such as any single aspect or any combination of aspects described below or in connection with one or more other processes described elsewhere herein.

In a first aspect, process 1000 includes prefixing each vector with a zero value in accordance with the length of the LP-WUS sequence.

In a second aspect, alone or in combination with the first aspect, the rate-matching pattern includes a vector having a first dimension, L and a second dimension, 1.

In a third aspect, alone or in combination with one or more of the first and second aspects, process 1000 includes an i^{th} entry in the rate-matching pattern has a value, j, and an i^{th} entry in the LP-WUS sequence has a same value as a j^{th} entry in the set of encoded information bits.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a UE, or a UE may include the apparatus 1100. In some aspects, the apparatus 1100 includes a reception component 1102, a transmission component 1104, or a communication manager 1106, which may be in communication with one another (for example, via one or more buses or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 140 described in connection with FIG. 1) of the UE.

In some aspects, the apparatus 1100 may be configured to perform one or more operations described herein. Additionally, or alternatively, the apparatus 1100 may be configured to perform one or more processes described herein, such as process 600 of FIG. 6, process 700 of FIG. 7, or a combination thereof. In some aspects, the apparatus 1100 or one or more components shown in FIG. 11 may include one or more components of the UE described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the UE described above in connection with FIG. 1, such as a radio, one or more RF chains, one or more transceivers, or one or more modems, each of which may in turn be coupled with one or more antennas of the UE.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1104 may be co-located with the reception component 1102.

The communication manager 1106 may support operations of the reception component 1102 or the transmission component 1104. For example, the communication manager 1106 may receive information associated with configuring reception of communications by the reception component 1102 or transmission of communications by the transmission component 1104. Additionally, or alternatively, the communication manager 1106 may generate or provide control information to the reception component 1102 or the transmission component 1104 to control reception or transmission of communications.

The communication manager 1106 may monitor for, during a monitoring occasion, an LP-WUS sequence including a plurality of multiplexed LP-WUS codepoints that are rate-matched according to a minimum Hamming distance that is a function of a length of the LP-WUS sequence. The communication manager 1106 may detect the LP-WUS sequence to obtain an LP-WUS associated with the UE, wherein each codepoint of the plurality of multiplexed LP-WUS codepoints is generated according to a set of generator matrices that are associated with the minimum Hamming distance. The reception component 1102 may receive a control channel message in association with detecting the LP-WUS sequence.

The communication manager 1106 may rate-dematch the LP-WUS sequence. The communication manager 1106 may apply a fast Hadamard transform to the rate-dematched LP-WUS sequence. The communication manager 1106 may detect, according to correlation-based detection, the LP-WUS sequence, wherein the minimum Hamming distance is at least half the length of the LP-WUS sequence in accordance with the correlation-based detection.

The communication manager 1106 may monitor for, during a monitoring occasion, an LP-WUS sequence including a plurality of multiplexed LP-WUS codepoints that are rate-matched according to a minimum Hamming distance that is a function of a length of the LP-WUS sequence. The communication manager 1106 may detect the LP-WUS sequence to obtain an LP-WUS associated with the UE, wherein each codepoint of the plurality of multiplexed LP-WUS codepoints is generated according to a Reed Muller encoding scheme. The reception component 1102 may receive a control channel message in association with detecting the LP-WUS sequence.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a network node, or a network node may include the apparatus 1200. In some aspects, the apparatus 1200 includes a reception component 1202, a transmission component 1204, or a communication manager 1206, which may be in communication with one another (for example, via one or more buses or one or more other components). In some aspects, the communication manager 1206 is the communication manager 155 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 145 described in connection with FIG. 1) of the network node.

In some aspects, the apparatus 1200 may be configured to perform one or more operations described herein. Additionally, or alternatively, the apparatus 1200 may be configured to perform one or more processes described herein, such as process 800 of FIG. 8, process 900 of FIG. 9, process 1000 of FIG. 10, or a combination thereof. In some aspects, the apparatus 1200 or one or more components shown in FIG. 12 may include one or more components of the network node described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the network node described above in connection with FIG. 1, such as a radio, one or more RF chains, one or more transceivers, or one or more modems, each of which may in turn be coupled with one or more antennas of the network node. In some aspects, the reception component 1202 or the transmission component 1204 may include or may be included in a network interface. The network interface may be configured to obtain or output signals for the apparatus 1200 via one or more communications links, such as a backhaul link, a midhaul link, or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1204 may be co-located with the reception component 1202.

The communication manager 1206 may support operations of the reception component 1202 or the transmission component 1204. For example, the communication manager 1206 may receive information associated with configuring reception of communications by the reception component 1202 or transmission of communications by the transmission component 1204. Additionally, or alternatively, the communication manager 1206 may generate or provide control information to the reception component 1202 or the transmission component 1204 to control reception or transmission of communications.

The communication manager 1206 may generate an LP-WUS sequence including a plurality of multiplexed LP-WUS codepoints that are rate-matched according to a minimum Hamming distance that is a function of a length of the LP-WUS sequence. The transmission component 1204 may transmit, during a monitoring occasion associated with a UE, the LP-WUS sequence, wherein each codepoint of the plurality of multiplexed LP-WUS codepoints is generated according to a set of generator matrices that are associated with the minimum Hamming distance. The transmission component 1204 may transmit a control channel message in association with transmitting the LP-WUS sequence.

The communication manager 1206 may generate each codepoint of the plurality of multiplexed LP-WUS codepoints by multiplying each of a set of binary vectors of a length, k by a generator matrix, of the set of generator matrices, having dimensions k×L, to obtain a set of 2^{k} codepoints each having a length, L.

The communication manager 1206 may generate, according to a correlation-based detection scheme, the LP-WUS sequence, wherein the minimum Hamming distance is at least half the length of the LP-WUS sequence in accordance with the correlation-based detection scheme.

The communication manager 1206 may generate an LP-WUS sequence including a plurality of multiplexed LP-WUS codepoints that are rate-matched according to a minimum Hamming distance that is a function of a length of the LP-WUS sequence. The transmission component 1204 may transmit, during a monitoring occasion associated with a UE, the LP-WUS sequence, wherein each codepoint of the plurality of multiplexed LP-WUS codepoints is generated according to a Reed Muller encoding scheme. The transmission component 1204 may transmit a control channel message in association with transmitting the LP-WUS sequence.

The communication manager 1206 may generate, according to a bit selection scheme that corresponds to the length of the LP-WUS sequence, the plurality of multiplexed LP-WUS codepoints using a Reed Muller encoding table.

The reception component 1202 may obtain a set of encoded information bits using a set of generator vectors. The communication manager 1206 may apply a rate-matching pattern to the set of encoded information bits to generate an LP-WUS sequence including a plurality of multiplexed LP-WUS codepoints, wherein the rate-matching pattern is a function of a length of the LP-WUS sequence.

The communication manager 1206 may prefix each vector with a zero value in accordance with the length of the LP-WUS sequence.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: monitoring for, during a monitoring occasion, a low-power wake-up signal (LP-WUS) sequence including a plurality of multiplexed LP-WUS codepoints that are rate-matched according to a minimum Hamming distance that is a function of a length of the LP-WUS sequence; detecting the LP-WUS sequence to obtain an LP-WUS associated with the UE, wherein each codepoint of the plurality of multiplexed LP-WUS codepoints is generated according to a set of generator matrices that are associated with the minimum Hamming distance; and receiving a control channel message in association with detecting the LP-WUS sequence.

Aspect 2: The method of Aspect 1, wherein detecting the LP-WUS sequence comprises: rate-dematching the LP-WUS sequence; and applying a fast Hadamard transform to the rate-dematched LP-WUS sequence.

Aspect 3: The method of any of Aspects 1-2, wherein the multiplexed LP-WUS codepoints are encoded to wake up a subset of UEs of a set of UEs that are each monitoring for the LP-WUS sequence during the monitoring occasion.

Aspect 4: The method of any of Aspects 1-3, wherein each codepoint of the plurality of multiplexed LP-WUS codepoints is generated by multiplying each of a set of binary vectors of a length, k by a generator matrix, of the set of generator matrices, having dimensions k×L, to obtain a set of 2 codepoints each having a length, L.

Aspect 5: The method of any of Aspects 1-4, wherein each generator matrix of the set of generator matrices includes a plurality of non-zero binary vectors according to a selected length of the LP-WUS sequence.

Aspect 6: The method of any of Aspects 1-5, wherein detecting the LP-WUS sequence comprises: detecting, according to correlation-based detection, the LP-WUS sequence, wherein the minimum Hamming distance is at least half the length of the LP-WUS sequence in accordance with the correlation-based detection.

Aspect 7: The method of any of Aspects 1-6, wherein the set of generator matrices is generated by omitting at least one all-zero row from each generator matrix of the set of generator matrices.

Aspect 8: The method of any of Aspects 1-7, wherein the set of generator matrices includes a quantity of matrices.

Aspect 9: The method of any of Aspects 1-8, wherein: each generator matrix of the set of generator matrices has a first dimension, 2^{k}−1, and a second dimension, k, and a value of 2^{k} corresponds to a quantity of LP-WUS codepoints in the plurality of multiplexed LP-WUS codepoints.

Aspect 10: The method of any of Aspects 1-9, wherein each codepoint of the plurality of multiplexed LP-WUS codepoints is generated according to a selected generator matrix of the set of generator matrices that corresponds to the length of the LP-WUS sequence.

Aspect 11: The method of any of Aspects 1-10, wherein one or more columns of each generator matrix of the set of generator matrices are swapped with one or more other columns of the corresponding generator matrix to satisfy the minimum Hamming distance for each of a plurality of sequence lengths to generate the set of generator matrices.

Aspect 12: The method of any of Aspects 1-11, wherein each codepoint of the plurality of multiplexed LP-WUS codepoints is rate-matched to the length of the LP-WUS sequence in accordance with the minimum Hamming distance.

Aspect 13: The method of any of Aspects 1-12, wherein a quantity of the plurality of multiplexed LP-WUS codepoints corresponds to a set of LP-WUS sequence lengths.

Aspect 14: The method of Aspect 13, wherein the length of the LP-WUS sequence is selected from the set of LP-WUS sequence lengths corresponding to the quantity of the plurality of multiplexed LP-WUS codepoints.

Aspect 15: The method of any of Aspects 13-14, wherein the length of the LP-WUS sequence is equal to a power, m, of a base of 2, and the quantity of the plurality of multiplexed LP-WUS codepoints is equal to 2m+1.

Aspect 16: The method of any of Aspects 1-15, wherein the length of the LP-WUS sequence is selected in accordance with at least one of a false alarm rate, a noise threshold, or a quality of service threshold.

Aspect 17: The method of any of Aspects 1-16, wherein the set of generator matrices is selected to correspond to a quantity of encoded bits in the LP-WUS sequence.

Aspect 18: A method of wireless communication performed by a user equipment (UE), comprising: monitoring for, during a monitoring occasion, a low-power wake-up signal (LP-WUS) sequence including a plurality of multiplexed LP-WUS codepoints that are rate-matched according to a minimum Hamming distance that is a function of a length of the LP-WUS sequence; detecting the LP-WUS sequence to obtain an LP-WUS associated with the UE, wherein each codepoint of the plurality of multiplexed LP-WUS codepoints is generated according to a Reed Muller encoding scheme; and receiving a control channel message in association with detecting the LP-WUS sequence.

Aspect 19: The method of Aspect 18, wherein the plurality of multiplexed LP-WUS codepoints are generated according to a Reed Muller encoding table and a bit selection scheme that corresponds to the length of the LP-WUS sequence.

Aspect 20: The method of any of Aspects 18-19, wherein: the Reed Muller encoding scheme includes a plurality of generator vectors, and a quantity of LP-WUS codepoints in the plurality of multiplexed LP-WUS codepoints is associated with a selected length of the LP-WUS sequence.

Aspect 21: The method of Aspect 20, wherein the LP-WUS sequence is rate-matched to correspond to a sequence length of a first set of sequence lengths by using an input to determine the plurality of generator vectors that includes a padded zero at a beginning of the input, or the LP-WUS sequence is rate-matched to correspond to a sequence length of a second set of sequence lengths by using an input to determine the plurality of generator vectors that does not include a padded zero at a beginning of the input.

Aspect 22: The method of any of Aspects 20-21, wherein each generator vector of the plurality of generator vectors corresponds to a selected length of the LP-WUS sequence.

Aspect 23: The method of any of Aspects 20-22, wherein each generator vector of the plurality of generator vectors has a length of 2^{k}−1.

Aspect 24: The method of any of Aspects 20-23, wherein an end of each generator vector of the plurality of generator vectors includes an additional entry to rate-match the LP-WUS sequence to correspond to a sequence length that is a power of two.

Aspect 25: The method of any of Aspects 18-24, wherein the length of the LP-WUS sequence is selected in accordance with at least one of a false alarm rate, a noise threshold, or a quality of service threshold.

Aspect 26: A method of wireless communication performed by a network node, comprising: generating a low-power wake-up signal (LP-WUS) sequence including a plurality of multiplexed LP-WUS codepoints that are rate-matched according to a minimum Hamming distance that is a function of a length of the LP-WUS sequence; transmitting, during a monitoring occasion associated with a user equipment (UE), the LP-WUS sequence, wherein each codepoint of the plurality of multiplexed LP-WUS codepoints is generated according to a set of generator matrices that are associated with the minimum Hamming distance; and transmitting a control channel message in association with transmitting the LP-WUS sequence.

Aspect 27: The method of Aspect 26, wherein the multiplexed LP-WUS codepoints are encoded to wake up a subset of UEs of a set of UEs that are each monitoring for the LP-WUS sequence during the monitoring occasion.

Aspect 28: The method of any of Aspects 26-27, further comprising: generating each codepoint of the plurality of multiplexed LP-WUS codepoints by multiplying each of a set of binary vectors of a length, k by a generator matrix, of the set of generator matrices, having dimensions k×L, to obtain a set of 2^{k} codepoints each having a length, L.

Aspect 29: The method of any of Aspects 26-28, wherein each generator matrix of the set of generator matrices includes a plurality of non-zero binary vectors according to a selected length of the LP-WUS sequence.

Aspect 30: The method of any of Aspects 26-29, wherein generating the LP-WUS sequence comprises: generating, according to a correlation-based detection scheme, the LP-WUS sequence, wherein the minimum Hamming distance is at least half the length of the LP-WUS sequence in accordance with the correlation-based detection scheme.

Aspect 31: The method of any of Aspects 26-30, wherein the set of generator matrices is generated by omitting at least one all-zero row from each generator matrix of the set of generator matrices.

Aspect 32: The method of any of Aspects 26-31, wherein the set of generator matrices includes a quantity of matrices.

Aspect 33: The method of any of Aspects 26-32, wherein: each generator matrix of the set of generator matrices has a first dimension, 2^{k}−1 and a second dimension, k, and a value of 2^{k} corresponds to a quantity of LP-WUS codepoints in the plurality of multiplexed LP-WUS codepoints.

Aspect 34: The method of any of Aspects 26-33, wherein each codepoint of the plurality of multiplexed LP-WUS codepoints is generated according to a selected generator matrix of the set of generator matrices that corresponds to the length of the LP-WUS sequence.

Aspect 35: The method of any of Aspects 26-34, wherein one or more columns of each generator matrix of the set of generator matrices are swapped with one or more other columns of the corresponding generator matrix to satisfy the minimum Hamming distance for each of a plurality of sequence lengths to generate the set of generator matrices.

Aspect 36: The method of any of Aspects 26-35, wherein each codepoint of the plurality of multiplexed LP-WUS codepoints is rate-matched to the length of the LP-WUS sequence in accordance with the minimum Hamming distance.

Aspect 37: The method of any of Aspects 26-36, wherein a quantity of the plurality of multiplexed LP-WUS codepoints corresponds to a set of LP-WUS sequence lengths.

Aspect 38: The method of Aspect 37, wherein the length of the LP-WUS sequence is selected from the set of LP-WUS sequence lengths corresponding to the quantity of the plurality of multiplexed LP-WUS codepoints.

Aspect 39: The method of any of Aspects 37-38, wherein the length of the LP-WUS sequence is equal to a power, m, of a base of 2, and the quantity of the plurality of multiplexed LP-WUS codepoints is equal to 2m+1.

Aspect 40: The method of any of Aspects 26-39, wherein the length of the LP-WUS sequence is selected in accordance with at least one of a false alarm rate, a noise threshold, or a quality of service threshold.

Aspect 41: The method of any of Aspects 26-40, wherein the set of generator matrices is selected to correspond to a quantity of encoded bits in the LP-WUS sequence.

Aspect 42: A method of wireless communication performed by a network node, comprising: generating a low-power wake-up signal (LP-WUS) sequence including a plurality of multiplexed LP-WUS codepoints that are rate-matched according to a minimum Hamming distance that is a function of a length of the LP-WUS sequence; transmitting, during a monitoring occasion associated with a user equipment (UE), the LP-WUS sequence, wherein each codepoint of the plurality of multiplexed LP-WUS codepoints is generated according to a Reed Muller encoding scheme; and transmitting a control channel message in association with transmitting the LP-WUS sequence.

Aspect 43: The method of Aspect 42, further comprising: generating, according to a bit selection scheme that corresponds to the length of the LP-WUS sequence, the plurality of multiplexed LP-WUS codepoints using a Reed Muller encoding table.

Aspect 44: The method of any of Aspects 42-43, wherein: the Reed Muller encoding scheme includes a plurality of generator vectors, and a quantity of LP-WUS codepoints in the plurality of multiplexed LP-WUS codepoints is associated with a selected length of the LP-WUS sequence.

Aspect 45: The method of Aspect 44, wherein the LP-WUS sequence is rate-matched to correspond to a sequence length of a first set of sequence lengths by using an input to determine the plurality of generator vectors that includes a padded zero at a beginning of the input, or the LP-WUS sequence is rate-matched to correspond to a sequence length of a second set of sequence lengths by using an input to determine the plurality of generator vectors that does not include a padded zero at a beginning of the input.

Aspect 46: The method of any of Aspects 44-45, wherein an end of each generator vector of the plurality of generator vectors includes an additional entry to rate-match the LP-WUS sequence to correspond to a sequence length that is a power of two.

Aspect 47: The method of any of Aspects 42-46, wherein the length of the LP-WUS sequence is selected in accordance with at least one of a false alarm rate, a noise threshold, or a quality of service threshold.

Aspect 48: A method of wireless communication, performed by a network node, comprising: obtaining a set of encoded information bits using a set of generator vectors; and applying a rate-matching pattern to the set of encoded information bits to generate a low-power wake-up signal (LP-WUS) sequence including a plurality of multiplexed LP-WUS codepoints, wherein the rate-matching pattern is a function of a length of the LP-WUS sequence.

Aspect 49: The method of Aspect 48, further comprising: prefixing each vector with a zero value in accordance with the length of the LP-WUS sequence.

Aspect 50: The method of any of Aspects 48-49, wherein the rate-matching pattern includes a vector having a first dimension, L and a second dimension, 1.

Aspect 51: The method of any of Aspects 48-50, wherein: an ith entry in the rate-matching pattern has a value, j, and an ith entry in the LP-WUS sequence has a same value as a jth entry in the set of encoded information bits.

Aspect 52: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-51.

Aspect 53: An apparatus for wireless communication at a device, the apparatus comprising one or more memories and one or more processors coupled to the one or more memories, the one or more processors configured to cause the device to perform the method of one or more of Aspects 1-51.

Aspect 54: An apparatus for wireless communication, the apparatus comprising at least one means for performing the method of one or more of Aspects 1-51.

Aspect 55: A non-transitory computer-readable medium storing code for wireless communication, the code comprising instructions executable by one or more processors to perform the method of one or more of Aspects 1-51.

Aspect 56: A non-transitory computer-readable medium storing a set of instructions for wireless communication, the set of instructions comprising one or more instructions that, when executed by one or more processors of a device, cause the device to perform the method of one or more of Aspects 1-51.

Aspect 57: A device for wireless communication, the device comprising a processing system that includes one or more processors and one or more memories coupled with the one or more processors, the processing system configured to cause the device to perform the method of one or more of Aspects 1-51.

Aspect 58: An apparatus for wireless communication at a device, the apparatus comprising one or more memories and one or more processors coupled to the one or more memories, the one or more processors individually or collectively configured to cause the device to perform the method of one or more of Aspects 1-51.

Aspect 59: A device comprising a processing system that includes one or more processors and one or more code-storing memories coupled with the one or more processors, the processing system configured to cause the device to perform the method of one or more of Aspects 1-51.

Aspect 60: A device comprising a processing system that includes processor circuitry and code-storing memory circuitry, the processing system configured to cause the device to perform the method of one or more of Aspects 1-51.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A network node, comprising:
a processing system that includes one or more processors and one or more code-storing memories coupled with the one or more processors, the processing system configured to cause the network node to:
generate a low-power wake-up signal (LP-WUS) sequence including a plurality of multiplexed LP-WUS codepoints that are rate-matched according to a minimum Hamming distance that is a function of a length of the LP-WUS sequence;
transmit, during a monitoring occasion associated with a user equipment (UE), the LP-WUS sequence, wherein each codepoint of the plurality of multiplexed LP-WUS codepoints is generated according to a set of generator matrices that are associated with the minimum Hamming distance; and
transmit a control channel message in association with transmitting the LP-WUS sequence.

2. The network node of claim 1, wherein the processing system is configured to cause the network node to:
generate each codepoint of the plurality of multiplexed LP-WUS codepoints by multiplying each of a set of binary vectors of a length, k by a generator matrix, of the set of generator matrices, having dimensions k×L, to obtain a set of 2k codepoints each having a length, L.

3. The network node of claim 1, wherein each generator matrix of the set of generator matrices includes a plurality of non-zero binary vectors according to a selected length of the LP-WUS sequence.

4. The network node of claim 1, wherein the processing system, to cause the network node to generate the LP-WUS sequence, is configured to cause the network node to:
generate, according to a correlation-based detection scheme, the LP-WUS sequence, wherein the minimum Hamming distance is at least half the length of the LP-WUS sequence in accordance with the correlation-based detection scheme.

5. The network node of claim 1, wherein the set of generator matrices is generated by omitting at least one all-zero row from each generator matrix of the set of generator matrices.

6. The network node of claim 1, wherein:
each generator matrix of the set of generator matrices has a first dimension, 2k−1 and a second dimension, k, and
a value of 2k corresponds to a quantity of LP-WUS codepoints in the plurality of multiplexed LP-WUS codepoints.

7. The network node of claim 1, wherein each codepoint of the plurality of multiplexed LP-WUS codepoints is generated according to a selected generator matrix of the set of generator matrices that corresponds to the length of the LP-WUS sequence.

8. The network node of claim 1, wherein one or more columns of each generator matrix of the set of generator matrices are swapped with one or more other columns of the corresponding generator matrix to satisfy the minimum Hamming distance for each of a plurality of sequence lengths to generate the set of generator matrices.

9. The network node of claim 1, wherein each codepoint of the plurality of multiplexed LP-WUS codepoints is rate-matched to the length of the LP-WUS sequence in accordance with the minimum Hamming distance.

10. The network node of claim 1, wherein:
a quantity of the plurality of multiplexed LP-WUS codepoints corresponds to a set of LP-WUS sequence lengths, and
the length of the LP-WUS sequence is selected from the set of LP-WUS sequence lengths corresponding to the quantity of the plurality of multiplexed LP-WUS codepoints.

11. The network node of claim 10, wherein the length of the LP-WUS sequence is equal to a power, m, of a base of 2, and the quantity of the plurality of multiplexed LP-WUS codepoints is equal to 2m+1.

12. The network node of claim 1, wherein the length of the LP-WUS sequence is selected in accordance with at least one of a false alarm rate, a noise threshold, or a quality of service threshold.

13. A network node, comprising:
a processing system that includes one or more processors and one or more code-storing memories coupled with the one or more processors, the processing system configured to cause the network node to:
generate a low-power wake-up signal (LP-WUS) sequence including a plurality of multiplexed LP-WUS codepoints that are rate-matched according to a minimum Hamming distance that is a function of a length of the LP-WUS sequence;
transmit, during a monitoring occasion associated with a user equipment (UE), the LP-WUS sequence, wherein each codepoint of the plurality of multiplexed LP-WUS codepoints is generated according to a Reed Muller encoding scheme; and
transmit a control channel message in association with transmitting the LP-WUS sequence.

14. The network node of claim 13, wherein the processing system is configured to cause the network node to:
generate, according to a bit selection scheme that corresponds to the length of the LP-WUS sequence, the plurality of multiplexed LP-WUS codepoints using a Reed Muller encoding table.

15. The network node of claim 13, wherein:
the Reed Muller encoding scheme includes a plurality of generator vectors, and
a quantity of LP-WUS codepoints in the plurality of multiplexed LP-WUS codepoints is associated with a selected length of the LP-WUS sequence.

16. The network node of claim 15, wherein:
the LP-WUS sequence is rate-matched to correspond to a sequence length of a first set of sequence lengths by using an input to determine the plurality of generator vectors that includes a padded zero at a beginning of the input, or
the LP-WUS sequence is rate-matched to correspond to a sequence length of a second set of sequence lengths by using an input to determine the plurality of generator vectors that does not include a padded zero at a beginning of the input.

17. The network node of claim 15, wherein an end of each generator vector of the plurality of generator vectors includes an additional entry to rate-match the LP-WUS sequence to correspond to a sequence length that is a power of two.

18. A network node, comprising:
a processing system that includes one or more processors and one or more code-storing memories coupled with the one or more processors, the processing system configured to cause the network node to:
obtain a set of encoded information bits using a set of generator vectors; and
apply a rate-matching pattern to the set of encoded information bits to generate a low-power wake-up signal (LP-WUS) sequence including a plurality of multiplexed LP-WUS codepoints, wherein the rate-matching pattern is a function of a length of the LP-WUS sequence.

19. The network node of claim 18, wherein the processing system is configured to cause the network node to:
prefix each vector with a zero value in accordance with the length of the LP-WUS sequence.

20. The network node of claim 18, wherein:
an ith entry in the rate-matching pattern has a value, j, and
an ith entry in the LP-WUS sequence has a same value as a jth entry in the set of encoded information bits.
